(19) United States
(12) Patent Application Publication
(10) Pub. No.: US 2026/0311507 A1
(43) Pub. Date: Oct. 8, 2026

(54) Learning Foundation Models from Anatomy in Medical Imaging via Self-Supervision

(71) Applicants: Mohammad Reza HOSSEINZADEH TAHER, Tempe, AZ (US); Jianming LIANG, Scottsdale, AZ (US)

(72) Inventors: Mohammad Reza HOSSEINZADEH TAHER, Tempe, AZ (US); Jianming LIANG, Scottsdale, AZ (US)

(73) Assignee: Arizona Board of Regents on Behalf of Arizona State University, Scottsdale, AZ (US)

(21) Appl. No.: 19/641,409

(22) Filed: Apr. 7, 2026

Related U.S. Application Data
(60) Provisional application No. 63/784,877, filed on Apr. 7, 2025.

(51) Int. Cl. G06V 40/10; G06V 10/26; G06V 10/82

(52) U.S. Cl. CPC G06V 40/10; G06V 10/26; G06V 10/82; G06V 2201/03

(57) ABSTRACT

A computer-implemented method that represents part-whole hierarchies in human anatomy models given a set of medical images. The method explicitly learns, via a self-supervised learning framework, to encode inherent part-whole hierarchies of anatomical structures in the plurality of medical images by acquiring discriminative representations to distinguish different anatomical structures, learning each anatomical structure in a parts-to-whole manner, and learning each anatomical structure in a whole-to-parts manner.

### CLAIM OF PRIORITY

This application claims the benefit of U.S. Provisional Patent Application No. 63/784,877, filed Apr. 7, 2025, entitled “LEARNING FOUNDATION MODELS FROM ANATOMY VIA SELF-SUPERVISION”, the disclosure of which is incorporated by reference herein in its entirety.

### GOVERNMENT RIGHTS AND GOVERNMENT AGENCY SUPPORT NOTICE

This invention was made with government support under R01 HL128785 awarded by the National Institutes of Health. The government has certain rights in the invention.

### COPYRIGHT NOTICE

This document contains material which is subject to copyright protection. The copyright owner has no objection to the facsimile reproduction by anyone of the document as it appears in the Patent and Trademark Office records but otherwise reserves all copyright rights whatsoever.

### BACKGROUND

Foundation models represent a phase change in artificial intelligence (AI) by exhibiting advanced functionalities that emerge naturally without explicit training and enable these models to flexibly adapt across a diverse range of tasks with minimal or no additional training. On a technical level, foundation models unlock new emergent capabilities and offer versatility across tasks by harnessing the power of deep neural networks and transfer learning, typically leveraging pretraining via self-supervision at scale. A pretraining strategy makes foundation models possible while a pretraining scale makes them powerful.

To date, natural language processing (NLP) has been the field most profoundly transformed by foundation models. Foundation models like GPT-4 (OpenAI 2023), DALL E, and Imagen, pretrained via self-supervised learning (SSL), have reshaped NLP and vision-language modeling, capturing widespread media attention. Yet similar success remains elusive in medical imaging, even with the scarcity of annotated data that challenges deep learning in this field, where numerous SSL methods have nonetheless been developed. What accounts for these stark differences? SSL methods in NLP, such as masked language modeling, have proven powerful in capturing the underlying structures (i.e., a foundation) of the English language, allowing intrinsic language properties to emerge naturally. In contrast, existing SSL methods lack such capabilities to appreciate the foundation of medical imaging which is human anatomy.

Therefore, the disclosed embodiments address a critical question: How can foundation models learn from human anatomy in medical imaging through self-supervision?

Human anatomy is the foundation of medical imaging and has an important characteristic: it's hierarchical in nature, exhibiting two intrinsic properties: (1) locality: each anatomical structure is morphologically distinct from the others; and (2) compositionality and decompositionality: each anatomical structure is an integrated part of a larger whole, and vice versa, each anatomical structure (i.e., whole) can be broken down into its smaller constituent parts. A trustworthy foundation model for medical imaging should be consciously and purposefully developed upon this foundation from the very start, to gain the capability of “understanding” human anatomy and to possess the fundamental properties of medical imaging. However, densely annotating human anatomy at scale by experts for training foundation models to understand human anatomy via supervised learning is impractical.

### Transfer Learning

Deep neural networks have revolutionized the field of computer vision, but training these networks from scratch requires a large amount of annotated data, posing a significant challenge in the medical imaging domain where expert annotations are both costly and time-consuming to obtain. Transfer learning offers a promising solution to resolve this challenge by reusing knowledge from a source domain to enhance performance in a target domain. In this paradigm, models pretrained on large datasets are fine-tuned for specific tasks, enabling faster convergence and improved performance, particularly when annotated data is scarce. The following discussion reviews the works related to transfer learning from multiple perspectives.

Transfer Learning from Photograph Datasets

Fine-tuning models pretrained on large-scale photographic datasets, particularly ImageNet, through supervised learning remains the predominant transfer learning strategy for medical imaging applications. Numerous studies have investigated the effectiveness of supervised ImageNet models, demonstrating their transferability across a wide range of medical imaging tasks. Prior work has compared the performance of fine-tuning supervised ImageNet models with training models from scratch across four applications involving colonoscopy, CT, and ultrasonographic imaging modalities, revealing that fine-tuning ImageNet models either outperformed or achieved comparable performance to models trained from scratch, with the added benefit of faster convergence. Furthermore, the performance gap between fine-tuned models and those trained from scratch widened as the size of the training sets decreased. Similarly, prior work has demonstrated the effectiveness of transfer learning from supervised ImageNet models for tasks such as lymph node detection and interstitial lung disease classification. Prior work has demonstrated that fine-tuning supervised ImageNet models outperforms training target models from scratch on the CheXpert dataset across various CNN architectures. The impact of fine-tuning supervised ImageNet models for classification tasks in chest X-ray and fundus images has been investigated, demonstrating that transfer learning provides substantial advantages, particularly in scenarios with limited data and when leveraging larger model architectures. Prior work has examined the impact of scaling pretraining data and model size on transfer learning from photographic datasets for various medical classification tasks, revealing that models pretrained on larger-scale datasets (e.g., ImageNet-21K and JFT-300M) and leveraging larger architectures achieve superior performance, faster convergence, and greater robustness to domain shifts compared to the standard supervised ImageNet-1K model.

Given the success of ImageNet models in medical imaging applications, a line of research has explored the factors that make transfer learning from ImageNet to medical datasets effective. The benefits of transfer learning are generally hypothesized to stem from the reuse of pretrained features in downstream tasks, where the weights learned in the source domain provide features that can be directly leveraged in the target domain. Contrary to this hypothesis, earlier studies suggested that the observed gains from transferring ImageNet models to medical tasks were largely driven by weight scaling and low-level statistical alignment. More recent research has delved deeper into this phenomenon, examining target datasets with greater variety in size and distance from the ImageNet, as well as different model architectures. A study revealed that feature reuse plays a critical role in the success of transfer learning from ImageNet to medical tasks, particularly for models with less inductive bias (such as vision transformers), smaller datasets, and datasets more closely aligned with ImageNet. Another line of research has explored the influence of model architecture as a determining factor on the transferability of supervised ImageNet models to different datasets. However, in the medical imaging domain, existing studies are typically limited to specific applications or modalities, such as tuberculosis classification from chest X-rays or thoracic disease classification in chest X-rays. Furthermore, these studies predominantly focus on conventional ConvNet and vision transformer architectures, such as the ResNet, DenseNet, and ViT families.

Transfer Learning from Medical Datasets

Given the significant domain shift between photographic and medical images, transfer learning from models pretrained on medical datasets (i.e., in-domain pretraining) is arguably a more effective approach than using models pretrained on photographic datasets. As a result, a growing body of research has focused on investigating the pretraining of supervised models using medical imaging datasets. Prior work conducted experiments in controlled setups to compare supervised pretraining on medical datasets with ImageNet pretraining. By limiting the amount of ImageNet data to match the smaller size of medical datasets, they demonstrated that pretraining on medical datasets yields superior performance in disease classification but underperforms in segmentation tasks. Furthermore, their findings indicate that, in the absence of sufficiently large-scale medical datasets comparable to ImageNet, models pretrained on the full ImageNet dataset continue to outperform those pretrained on medical datasets. Recently, the RadImageNet models were developed using an extensive dataset of 1.35 million radiology images, spanning CT, MRI, and ultrasound modalities, 14 anatomies, and 165 disease labels. The RadImageNet models were trained using supervised learning to classify images according to their disease labels. The superior transfer performance of RadImageNet models over ImageNet models across multiple target tasks underscores the advantages of pretraining on millions of radiology images compared with photographic images. Despite the great potential of pretraining with in-domain medical datasets, the scarcity of large-scale annotated datasets across diverse medical imaging modalities limits the development of versatile pretrained models comparable to ImageNet in the medical domain.

Transfer Learning from Self-Supervised Models

Self-supervised pretraining is increasingly favored over supervised pretraining for transfer learning due to its ability to leverage unlabeled data, which is abundant and easier to obtain compared with labeled datasets. Unlike supervised pretraining, which learns features tied to specific labels in the source domain, self-supervised methods focus on uncovering intrinsic patterns within the data through pretext tasks, resulting in more generic and transferable representations across tasks and domains. To support this, existing research demonstrated the higher transferability of self-supervised ImageNet models over supervised ImageNet models to a range of computer vision tasks, particularly when there is domain shift between source and target datasets. Recent advancements in self-supervised techniques, such as contrastive learning and masked image modeling, have further closed the performance gap with supervised methods, making self-supervised pretraining a powerful and scalable solution for transfer learning.

With rapid advancements in pretraining strategies, encompassing supervised and self-supervised learning, numerous models have been developed with distinct architectures pretrained on various datasets using different strategies. But there is a lack of up-to-date evaluations of their transferability to medical imaging, posing a challenge for practitioners in selecting the most proper pretrained models for their tasks at hand. To fill this gap, this disclosure provides a fine-grained and up-to-date study on the transferability of various brand-new pretraining techniques for medical imaging tasks, answering central and timely questions on transfer learning in medical image analysis.

### Self-Supervised Learning

Self-supervised learning (SSL) methods aim to learn general representations from data without human supervision, enabling scalable pretraining by effectively leveraging the abundance of unlabeled data. Moreover, SSL often leads to models with enhanced generalization across tasks and domains, as the learned features are less biased toward the source dataset/task. Existing SSL methods can be broadly categorized into two main groups based on their learning objectives: image-level approaches and dense prediction approaches. In the following sections, this disclosure reviews the literature for each category, followed by related works specific to the medical imaging domain.

### Image-Level Self-Supervised Learning

A large body of work on SSL seeks to learn global features by discriminating data samples at either the cluster-level or instance-level. Clustering methods group the data into clusters via a similarity metric, and train SSL models to distinguish these clusters. On the other hand, instance discrimination methods compel the SSL models to generate similar features for different views of the same image, employing various strategies to prevent trivial solutions: (i) Contrastive methods utilize negative samples to discriminate between images; (ii) Self-distillation methods bypass the need for negative pairs by training a student network to predict the features of a teacher network; and (iii) Feature decorrelation methods maximize the information content of the representations while also enforcing similarity between instances of the same image. Notably, recent works have explored instance discrimination for pretraining vision transformers (ViT). Despite their success, image-level SSL methods often fall short in capturing nuanced visual details within local image regions, potentially limiting their generalization to tasks that demand dense representations. By contrast, the disclosed embodiments involve SSL methods that capture distinctive dense anatomical representations in a hierarchy of scales, yielding more powerful models for medical imaging tasks.

### Dense Self-Supervised Learning

This line of research targets learning local features by encoding visual patterns embedded in smaller image regions. Masked image modeling methods mask/perturb random parts of the input image and reconstruct the missing parts at the pixel-level. While recent works have demonstrated promising results by employing large-scale transformer models, these methods fall short in modeling relations among different images, which may limit the discriminative power of the learned features. Dense contrastive learning methods, on the other hand, extend image-level contrastive learning for dense prediction tasks by mining correspondences between pixels at the same spatial location, similar pixels or patches in a feature map, or similar image regions. However, given the significant disparity between photographic and medical images, existing dense SSL methods appear to be sub-optimal in extracting a distinct set of representations from medical images, owing to ignoring the unique properties of medical images. The disclosed embodiments use SSL methods that address this limitation by exploiting a learning strategy based on anatomy underneath medical images, resulting in more robust and discriminative representations for medical imaging tasks.

### Self-Supervised Learning in Medical Imaging

Inspired by recent advancements in SSL for computer vision tasks, there has been a surge in its application to medical imaging tasks. SSL in medical imaging has been explored in both image-level and pixel-level forms. Existing studies focus on instance discrimination and image reconstruction pretext tasks, as well as their integration. However, current SSL methods often neglect anatomical hierarchies in their learning objectives, resulting in limited anatomy understanding capabilities. By contrast, the disclosed embodiments use SSL methods that leverage the hierarchical nature of anatomy to learn semantically rich features, yielding more powerful models for a broad variety of medical imaging tasks.

Learning from Anatomy Via Self-Supervision

The consistent and recurrent anatomical structures in medical images harbor rich semantics about human anatomy, thereby providing strong supervision signals for deep semantic representation learning via self-supervision. Recognizing the importance of anatomical structures for semantic representation learning, recent SSL methods have integrated anatomical information into their learning objectives. Prior work introduced a pretext task focused on reconstructing anatomical patterns from transformed versions, which were generated through a series of image transformations. Prior work proposed a framework for self-discovery, self-classification, and self-restoration of anatomical patterns to enrich representation learning with semantics of anatomy, with subsequent enhancements via adversarial learning. Prior work proposed a pretext task aimed at predicting the spatial order of anatomical patterns and restoring the original appearance of distorted anatomical patterns to learn spatial anatomical relationships. This framework was later extended to enforce consistency of anatomical features at both global and local levels and further adapted to 3D images. Moreover, multiple studies exploited anatomical consistency in 3D medical images to generate more informative positive and negative pairs for contrastive learning. However, existing works neglect hierarchical anatomy relations. By contrast, Adam-v1 exploits the hierarchical nature of anatomy, progressively comprehending anatomy in a coarse-to-fine manner via hierarchical contrastive learning. Moreover, Adam-v2, according to the disclosed embodiments, explicitly captures part-whole hierarchies via its learning objectives. Compared with Adam-v1, Adam-v2 offers two significant advancements: (1) enhancing the localizability branch by eliminating negative pairs, thereby improving computational efficiency for large-scale pretraining, (2) introducing two novel components: composability and decomposability, which are crucial for capturing part-whole hierarchies.

### Foundation Models

Foundation models are deep models trained on broad data (often through self-supervised learning) and can be adapted (through transfer learning) to a wide range of downstream tasks. In recent years, the growing availability of data and computational resources has driven the development of foundation models that can address a broad range of tasks using a single generalist model. While significant strides in foundation models were first seen in natural language processing (NLP) due to the availability of large-scale text data, they are also becoming more prevalent in computer vision. However, foundation models for medical imaging are still nascent compared to their NLP or vision counterparts. Foundation models can be broadly categorized into three groups based on their learning strategies: models pretrained in a fully supervised manner with expert annotations, models pretrained in a self-supervised manner, and models pretrained via image-text supervision. The following sections delve into related works within each of these categories.

### Learning Foundation Models Via Expert Annotations

This line of work focuses on learning generalizable representations from readily available “gold-labels” in large-scale datasets using supervised learning techniques. In the computer vision domain, the availability of large-scale labeled datasets, such as ImageNet-21K, which contains 14 million images, and JFT-300M, which includes 300 million images, has enabled the development of highly capable foundation models. By leveraging this combination of massive datasets and large-scale architectures, these models have demonstrated exceptional performance in a wide range of vision tasks, including image classification, object detection, and segmentation. However, in medical imaging domain, the substantial cost associated with annotating medical images has led to a scarcity of large-scale medical imaging datasets, hindering the development of supervised foundation models. To address this challenge, multiple studies have focused on assembling data with heterogeneous labels from multiple sources to build large-scale datasets for supervised pretraining. For example, prior work gathered 1.35 million radiology images with disease labels from various imaging modalities to develop RadImageNet models. Other prior work assembled 821,544 labeled chest X-ray scans from public and private sources to train Google's proprietary CXR Foundation Model (CXR-FM). Prior work has aggregated heterogeneous expert annotations from six public datasets to train the Ark and Ark+ models on 704K chest X-ray images. Furthermore, prior work has collected expert image-level, bounding box, and segmentation mask disease labels from 11 public datasets to train Foundation X, a unified model for classification, localization, and segmentation tasks. Prior work created a large dataset consisting of over 6 million triples of image, segmentation mask, and textual description to train BiomedParse, a model capable of jointly conducting segmentation, detection, and recognition tasks across nine imaging modalities. Despite the promising success of supervised foundation models in learning transferable representations, their scalability is limited by the reliance on large-scale annotated datasets, which are costly and time-intensive to acquire in medical imaging. In contrast, the Adam-v2 model, according to the disclosed embodiments, is trained on a large corpus of data using self-supervised learning, removing the need for extensive annotated datasets.

### Learning Foundation Models Via Self-Supervision

Self-supervised learning presents a promising solution for developing foundation models due to its scalability, which arises from its ability to leverage abundant unlabeled data, offering a cost-effective and efficient alternative to supervised learning with expert annotations. Moreover, self-supervised models are designed to predict diverse aspects of the input data, enabling them to learn richer and more comprehensive representations compared to models trained on predefined and limited label spaces. Foundation models pretrained via self-supervised learning have revolutionized natural language processing, garnering significant public media attention. Inspired by their success in NLP, self-supervised foundation models in the medical imaging domain have recently garnered significant attention, highlighting their emerging importance and potential impact. Numerous works have developed foundation models for a variety of imaging modalities, including histopathology images, human genomic data, fundus images, and chest X-ray radiographs. For instance, prior work developed a foundation model for chest X-ray analysis using 1.04 million images and a masked image modeling pretext task. Other prior work developed the LVM-Med models using 1.3 million medical images from diverse modalities and a contrastive learning pretext task. Prior work pretrained the RayDINO model in a self-supervised manner using the DINOv2 pretext task on 870K chest X-ray images. Similarly, the RAD-DINO model was pretrained using the DINOv2 framework on 838K chest X-ray images. Prior work developed the EVA-X models using 520K chest X-ray images, where they formulated a pretext task by masking specific image patches and aligning the features of these masked patches between student and teacher networks. Despite the development of numerous SSL pretrained models in medical imaging, their success in this domain lags their NLP counterparts. This gap is attributed to the fact that SSL methods designed for NLP have been highly effective in capturing the underlying structure (i.e., the foundation) of the English language, while the existing SSL methods lack such capabilities to appreciate the foundation of medical imaging, that is, human anatomy. To bridge this gap, the disclosed embodiments use novel SSL training strategies that exploit the hierarchical nature of anatomy to learn semantics-rich dense anatomical features.

### Learning Foundation Models Via Image-Text

This line of research focuses on developing models that integrate text and image comprehension, enabling them to perform a wide range of tasks involving interactions between these modalities. Pioneering models in computer vision like CLIP and ALIGN leverage contrastive learning on large-scale image-text datasets to align visual and linguistic representations effectively. Models such as DALL E and Flamingo extend these capabilities by generating images from text or answering complex multimodal queries. Recently, multi-modal transformers, such as BLIP, have introduced more sophisticated cross-modal attention mechanisms, further improving performance on downstream tasks. In the medical imaging domain, vision-language models have been explored across various imaging modalities, including chest X-rays, CT scans, histopathology images, and multi-modal datasets. For instance, the CheXzero and ELIXR models were developed to align the features of chest X-ray images with raw radiology reports using a contrastive loss approach, demonstrating capabilities in zero-shot thoracic disease identification. Moreover, CheXagent was initially trained to align chest X-ray images with their corresponding radiology reports while distinguishing correct pairs from incorrect ones. It was further fine-tuned using image-instruction-answer triplets, enabling it to respond to instructions across a variety of chest X-ray interpretation tasks. Despite their success, the application of vision-language models to medical imaging remains underexplored compared to other domains, such as natural language processing, due to challenges like domain-specific data scarcity and the need for rigorous validation to ensure their safe integration into clinical settings.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1 illustrates fine-tuning various ImageNet pretrained models with popular network architectures to yield superior performance over training the target models from random initialization for a diverse set of medical applications, underscoring the importance of transfer learning in medical imaging.

FIG. 2 provides a graphical comparison of transfer learning from supervised ImageNet models across conventional and modern ConvNet and vision transformer architectures.

FIG. 3A graphically shows that fine-tuning data size plays a vital role in bridging the performance gap between ConvNets and vision transformers in medical imaging tasks.

FIG. 3B shows that the size of the training dataset impacts ConvNet and vision transformer models in both training from scratch and transfer learning settings.

FIGS. 4A-4K graphically illustrate that fine-tuning the models pretrained on large-scale finer grained datasets, namely iNat2021, ImageNet-22K, COCO, and Places365, offers a promising alternative to the de facto ImageNet-1K pretrained model for fine-grained medical applications.

FIGS. 5A-5K graphically illustrate that self-supervised learners can capture holistic features more effectively than their supervised counterparts, resulting in more generalizable representations for a variety of medical imaging tasks.

FIG. 6A illustrates that domain-adaptive pretraining serves as a vital bridge between the photographic and medical imaging domains, leading to improved performances compared with the standard ImageNet pretraining in all target tasks.

FIG. 6B illustrates that domain-adaptive pretraining can boost the performance of ImageNet models with modern ConvNet (i.e. ConvNeXt-B) and vision transformer (i.e. Swin-B) backbones.

FIG. 7 depicts human anatomy exhibiting natural hierarchies.

FIG. 8 illustrates that existing SSL methods lack capabilities of “understanding” the foundation of medical imaging, i.e., human anatomy.

FIG. 9 depicts an SSL strategy that gradually decomposes and perceives the anatomy in a coarse-to-fine manner in accordance with the disclosed embodiments.

FIG. 10 depicts a self-supervised learning framework, Adam-v2, according to the disclosed embodiments.

### WRITTEN DESCRIPTION

Foundation models signify a transformative leap in artificial intelligence, characterized by their efficient adaptation across diverse tasks with minimal or no additional training. However, their progress in medical imaging lags advancements in vision and vision-language domains, largely due to the absence of efficient learning strategies and standardized evaluation frameworks. To address these challenges and propel the development of foundation models in medical imaging, this disclosure focuses on three specific objectives: (1) conducting a large-scale systematic study to address critical and timely questions on transfer learning in medical image analysis; (2) providing a novel self-supervised learning framework based on the foundation of medical imaging—human anatomy—to endow models with the capability of understanding anatomy and capturing the fundamental properties of medical imaging, according to the disclosed embodiments; and (3) developing a comprehensive test suite to systematically evaluate foundation models across multiple dimensions relevant to medical imaging. These objectives advance deep learning-powered medical image analysis systems, equipping clinicians with tools to reduce diagnostic errors, enhance disease detection accuracy, streamline treatment planning, and ultimately improve patient outcomes while contributing to the evolution of medical imaging research and practice.

### 1. INTRODUCTION

Embodiments of the invention leverage self-supervised learning to exploit the hierarchical nature of human anatomy through the following specific aims:

Aim 1: Large-scale Benchmarking and Boosting Transfer Learning for Medical Image Analysis. Transfer learning, particularly, fine-tuning models pretrained on photographic images to medical images, has proven indispensable for medical image analysis. There are numerous models with distinct architectures pretrained on various datasets using different strategies. But there is a lack of up-to-date large-scale evaluations of their transferability to medical imaging, posing a challenge for practitioners in selecting the most proper pretrained models for their tasks at hand. A comprehensive systematic study was conducted, focusing on (i) benchmarking numerous conventional and modern convolutional neural network (ConvNet) and vision transformer architectures across various medical tasks; (ii) investigating the impact of fine-tuning data size on the performance of ConvNets compared with vision transformers in medical imaging; (iii) examining the impact of pretraining data granularity on transfer learning performance; (iv) evaluating transferability of a wide range of recent self-supervised methods with diverse training objectives to a variety of medical tasks across different modalities; and (v) delving into the efficacy of domain-adaptive pretraining on both photographic and medical datasets to develop high-performance models for medical tasks. One large-scale study (approximately 5000 experiments) yielded impactful insights: (1) ConvNets demonstrate higher transferability than vision transformers when fine-tuning for medical tasks; (2) ConvNets prove to be more annotation efficient than vision transformers when fine-tuning for medical tasks; (3) Fine-grained representations, rather than high-level semantic features, prove pivotal for fine-grained medical tasks; (4) Self-supervised models excel in learning holistic features compared with supervised models; and (5) Domain-adaptive pretraining leads to performant models via harnessing knowledge acquired from ImageNet and enhancing it through the utilization of readily accessible expert annotations associated with medical datasets.

Aim 2: Representing Part-Whole Hierarchies in Foundation Models by Learning Localizability, Composability, and Decomposability from Anatomy via Self-Supervision. Humans effortlessly interpret images by parsing them into part-whole hierarchies. Yet, deep learning models, despite excelling at capturing multi-level features, often fail to explicitly encode these part-whole hierarchies—an essential aspect of medical imaging, which involves anatomical hierarchies in nature. To address this limitation, the disclosed embodiments, referred to herein as Adam-v2, provide a self-supervised learning framework that explicitly learns to encode inherent part-whole hierarchies within medical images through three key branches: (1) Localizability, acquiring discriminative representations to distinguish different anatomical structures; (2) Composability, learning each anatomical structure in a parts-to-whole manner; and (3) Decomposability, comprehending each anatomical structure in a whole-to-parts manner. Extensive experiments showcase Adam-v2's advanced capability in anatomy understanding, unveiled through its embeddings (Eve-v2). Particularly, Eve-v2 demonstrates a zero-shot understanding of anatomy as revealed through its learned properties: 1) preserving localizability of anatomical structures, 2) encoding part-whole relations of anatomical structures as well as its emergent properties, 3) understanding anatomical layouts via interpolation and extrapolation, 4) associating each image pixel with (dense) semantic embeddings, 5) recognizing anatomical symmetries, 6) generating embeddings consistent across scales, and 7) matching anatomical structures across images of the same patient with different diseases, images of different patients, and augmented views of the same image. Adam-v2 also offers robust and generalizable representations and stands out in 8) few-shot and 9) full-transfer learning. These capabilities and performance directly stem from a crafted anatomy learning strategy, which explicitly constructs hierarchies for distinct anatomical structures from unlabeled medical images, according to the disclosed embodiments.

Aim 3: Developing a Comprehensive Test Suite for Analyzing Foundation Models in Medical Imaging. While foundation models hold promises for revolutionizing medical imaging, a gap remains in systematically evaluating their ability to robustly handle the complex and varied demands of this field. To fill this gap, a comprehensive test suite is disclosed herein, focusing on (i) detecting anomalies without training using a simple classifier; (ii) segmenting organs and lesions with limited annotated data; (iii) matching anatomical structures across patients without additional training; (iv) retrieving patterns in health or disease without task-specific training; (v) understanding anatomy without training; (vi) diagnosing common lung diseases; and (vii) localizing common lung diseases. The overarching goal of this test suite is to analyze the strengths and limitations of foundation models from medical and clinical perspectives, offering insights to advance foundation models leverage on minimal data while ensuring robust generalization across diverse healthcare contexts.

In the first aim, a fine-grained and up-to-date study on the transferability of various brand-new pretraining techniques for medical imaging tasks is provided, answering central and timely questions on transfer learning in medical image analysis. In the second aim, a novel self-supervised learning framework is provided that explicitly incorporates part-whole hierarchies into its learning objectives, demonstrating the importance of constructing a hierarchy of embeddings that can be autodidactically learned from anatomy (the foundation of medical imaging) and that can enhance the generalizability and robustness of representation learning, according to the disclosed embodiments. In the final aim, a comprehensive test suite is used to systematically analyze foundation models from several aspects, offering insights to guide the development of more effective foundation models for medical imaging. In summary, this disclosure aims to elevate conventional deep learning-powered medical image analysis systems to a new level of capability, supporting clinicians in reducing diagnostic errors, enhancing disease detection accuracy, and streamlining treatment planning, ultimately accelerating diagnoses and enabling timely, life-saving interventions to improve patient outcomes.

### 2. LARGE-SCALE BENCHMARKING AND BOOSTING TRANSFER LEARNING FOR MEDICAL IMAGE ANALYSIS

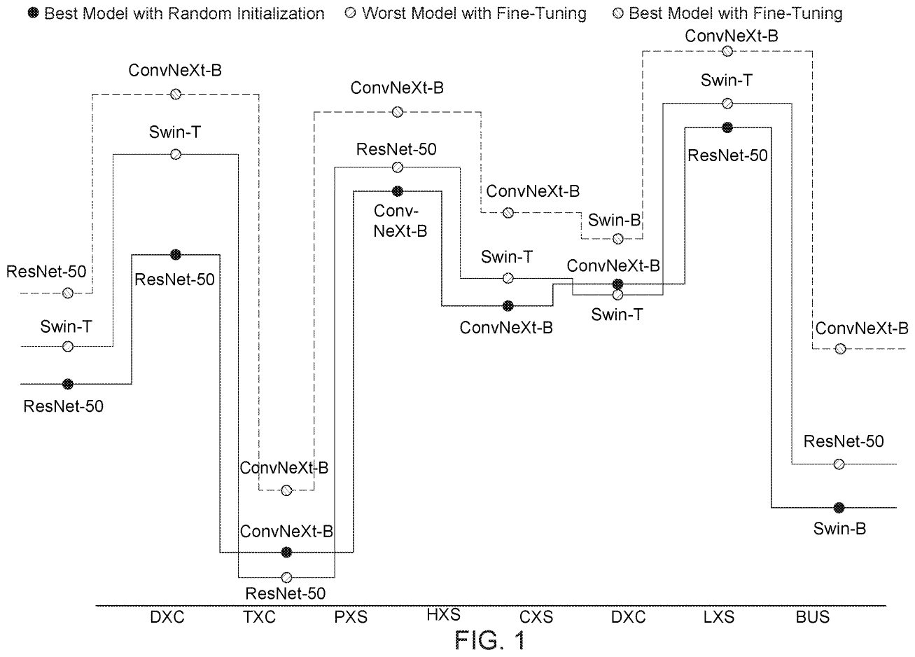

Fine-tuning models pretrained on large-scale photographic datasets (e.g. ImageNet) to medical images remains the de facto approach for circumventing the challenge of annotation scarcity in medical imaging. This dominance will continue for the foreseeable future, even with the rise of exploring alternative pretraining methods using medical data, largely due to the two reasons: first, photographic pretrained models—specifically supervised ImageNet models—for various backbones are readily accessible, offering superior performance over models trained from scratch. For example, FIG. 1 graphically illustrates that fine-tuning various ImageNet pretrained models with popular network architectures yields superior performance over training the target models from random initialization for a diverse set of medical applications, underscoring the importance of transfer learning in medical imaging. Second, owing to the diversity in shapes, textures, and colors inherent in photographic images, as opposed to the often visually homogeneous medical images, ImageNet models can acquire diverse visual representations, which are vital for effectively identifying different objects of interests (e.g., lesions or organs) in medical applications. A substantial portion of top-performing medical models across diverse applications, including identification of thoracic diseases, pulmonary embolism, skin cancer, and Alzheimer's disease, are fine-tuned from supervised ImageNet models.

There are many models of distinct architectures pretrained on various datasets with different strategies. However, the lack of a comprehensive evaluation assessing the transferability of these models to medical tasks poses challenges for practitioners in selecting the most suitable pretrained models in medical imaging, leaving several critical questions unanswered. As such, a large-scale empirical investigation (approximately 5,000 experiments) was conducted in the context of transfer learning for medical vision tasks, including a series of systematic experiments to explore the research questions and contributions that follow:

Question 1: Are pretrained ConvNets or vision transformers more transferable to medical imaging tasks? The debates about the superiority between vision transformers and convolutional neural networks (ConvNets) in computer vision recently leans towards vision transformers as viable alternatives to ConvNets. However, the lack of a broad study to compare efficacy of vision transformers and ConvNets in medical vision raises the question whether one could trivially switch to vision transformers. To bridge this gap, an extensive study (approximately 1,400 experiments) was conducted to benchmark numerous conventional and modern ConvNet and vision transformer architectures on various medical tasks. The findings reveal that ConvNeXt, a modernized ConvNet model, not only surpasses traditional ConvNets but also outperforms state-of-the-art (SOTA) vision transformers like Swin in a diverse set of medical tasks, emphasizing the continued relevance and effectiveness of ConvNets in medical imaging.

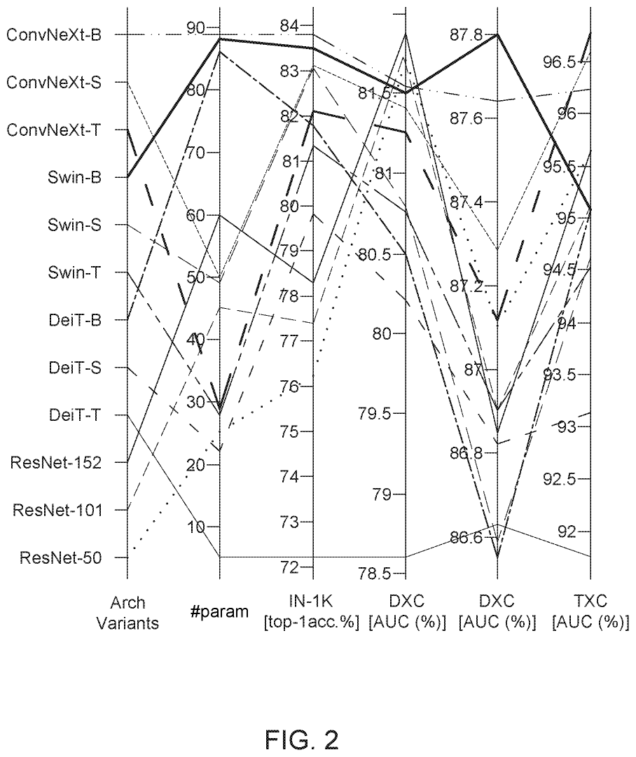

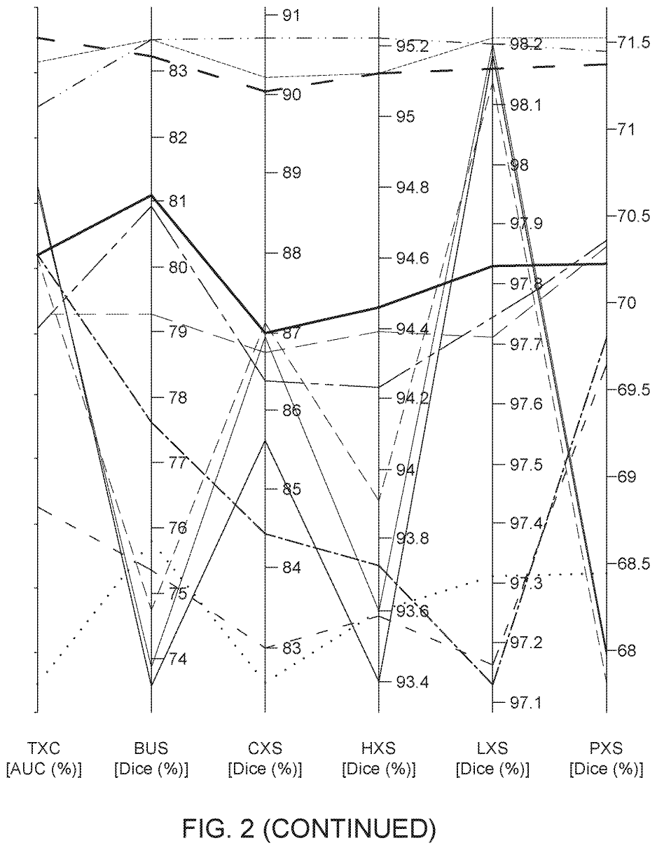

FIG. 2 provides a comparison of transfer learning from supervised ImageNet models across conventional and modern ConvNet and vision transformer architectures. ConvNext, among all architectural designs under study, consistently showcases superior performance within most of the target tasks, underscoring its potential for creating high-performance models for medical imaging applications. Specifically, the ConvNext-B pretrained model behaves consistently across all tasks, compared with the erratic patterns displayed by other pretrained models. In this parallel coordinate plot, four variables: architecture variants, the number of parameters in each pretrained model, ImageNet top-1 accuracy, and performance on various medical downstream tasks, have been covered. “Arch.” and “IN Acc” denote architecture and top-1 accuracy on ImageNet, respectively. Furthermore, within each of the model families ResNet-{50, 101, 152}, DeiT-{T, S, B}, Swin-{T, S, B}, and ConvNeXt-{T, S, B}), to distinguish different parameter sizes, different patterns have been used: models with fewer parameters have “dotted lines”, those with a moderate number of parameters have “dashed lines”, and those with more parameters have “solid lines”.

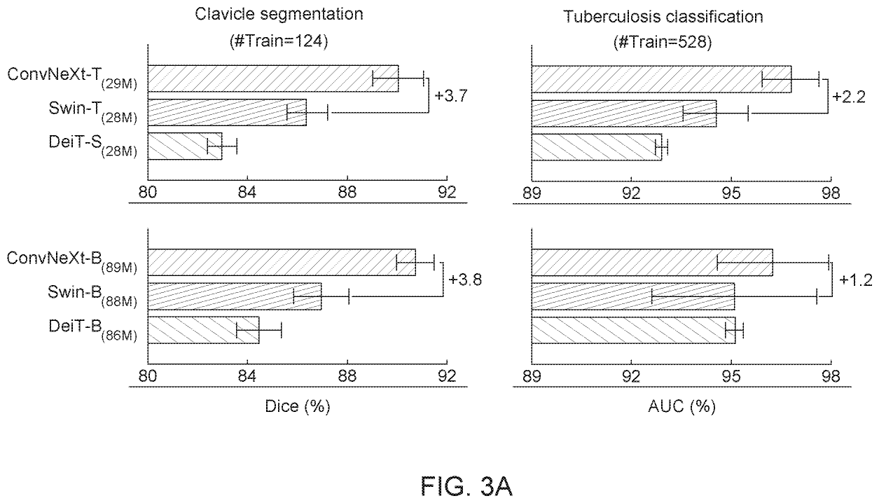

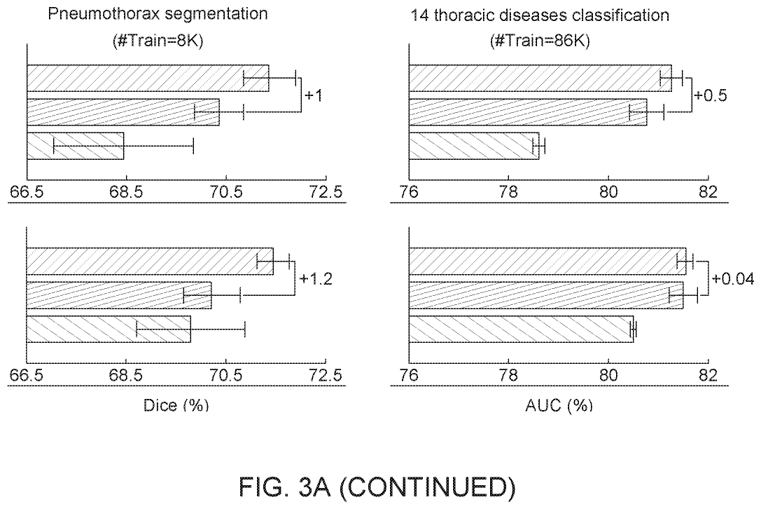

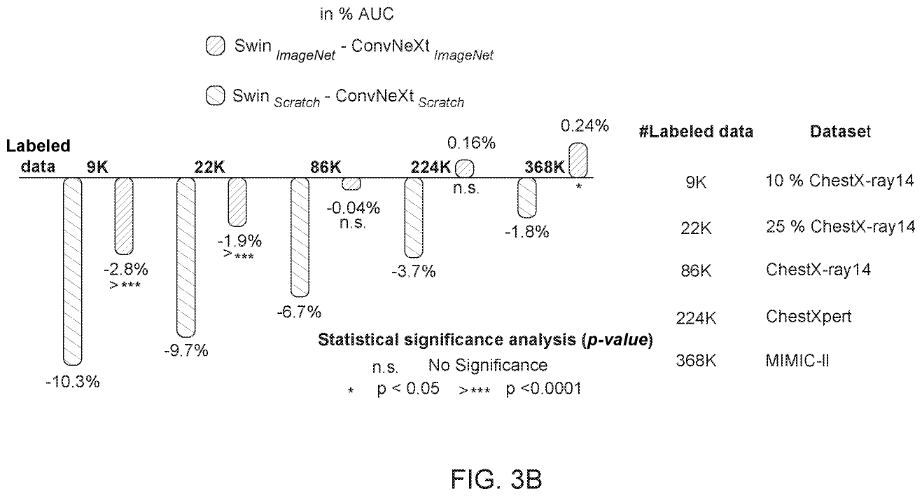

Question 2: Are pretrained ConvNets or vision transformers more annotation efficient for medical imaging tasks? Pretrained vision transformers have recently showcased superior performance compared with their ConvNet counterparts in some medical applications, particularly when fine-tuned with abundant labeled data. However, the lack of a comprehensive and up-to-date benchmark to dissect the behavior of pretrained ConvNets and vision transformers across various medical applications with different amounts of fine-tuning data, ranging from small to large, leaves a gap in understanding their transfer learning efficacy, especially in medical imaging tasks with a dearth of annotated data. To bridge this gap, a systematic study (approximately 400 experiments) was conducted to investigate the impact of fine-tuning data size (ranging from 100 to 368,000 samples) on the performance of vision transformers compared with ConvNets in medical imaging. The findings reveal that ConvNets are more annotation efficient than transformers when fine-tuned for medical tasks, while they also highlight that vision transformers have potential to favorably compete with ConvNets, particularly when substantial data is available. FIG. 3A shows that Fine-tuning data size plays a vital role in bridging the performance gap between ConvNets and vision transformers in medical imaging tasks. As seen, increasing the amount of fine-tuning data from the left most subfigure (clavicle segmentation with a small amount of fine-tuning data) to the right most subfigure (14 thoracic diseases classification with a substantially higher amount of fine-tuning data) leads to a decrease in the performance gap between ConvNet (i.e., ConvNeXt) and transformer (i.e., Swin and DeiT) models. Particularly, in the top row of the figure, increasing the amount of fine-tuning data narrows the performance gap between ConvNeXt-T and Swin-T for all tasks. Similarly, in the bottom row of the figure, the performance gap between ConvNeXt-B and the best performing transformer, either Swin-B or DeiT-B, decreases as the amount of fine-tuning data increases. These findings highlight the annotation efficiency advantage offered by pretrained ConvNet models in medical imaging tasks.

FIG. 3B shows that size of the training dataset impacts ConvNet and vision transformer models in both training from scratch and transfer learning settings. As seen, when trained from scratch, the ConvNeXt-B model displays consistent superiority over Swin-B, with the performance gap narrowing as the dataset size increases. Conversely, in the transfer learning setup, Swin-B initially lags ConvNeXt-B but gradually overtakes it as the fine-tuning dataset size grows. These results highlight the superior annotation efficiency of ConvNets compared with vision transformers and underscore the vision transformers' potential for medical imaging tasks when abundant data is available.

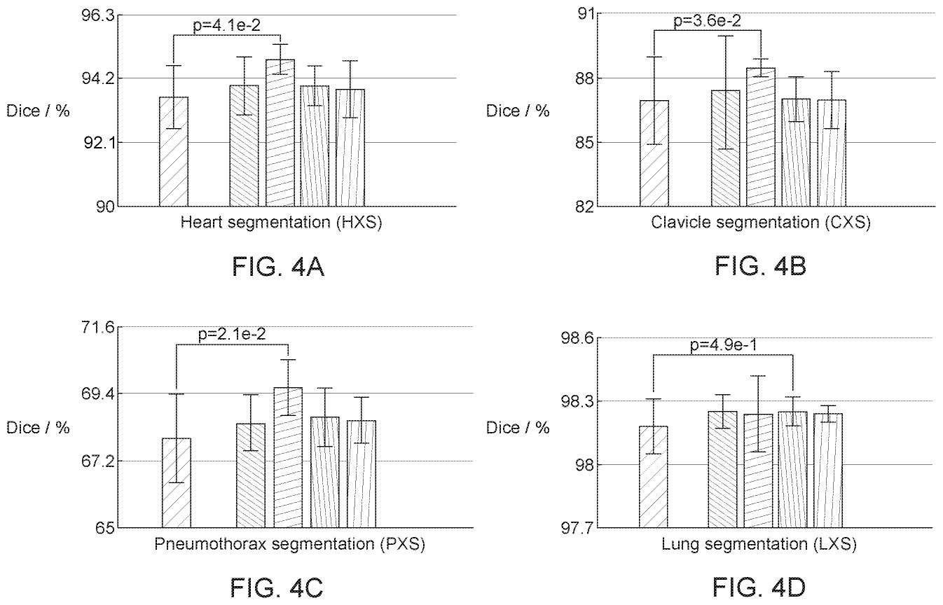

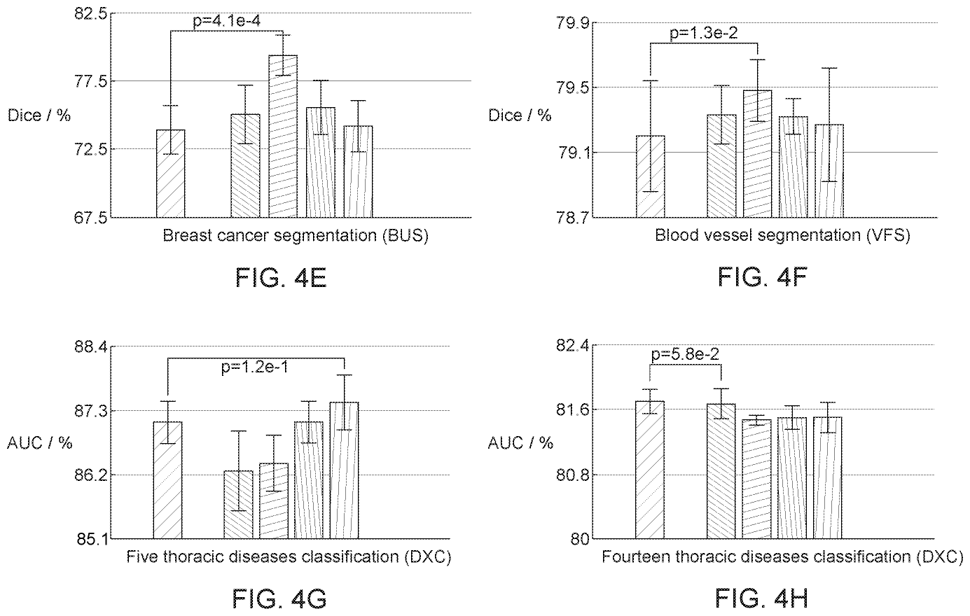

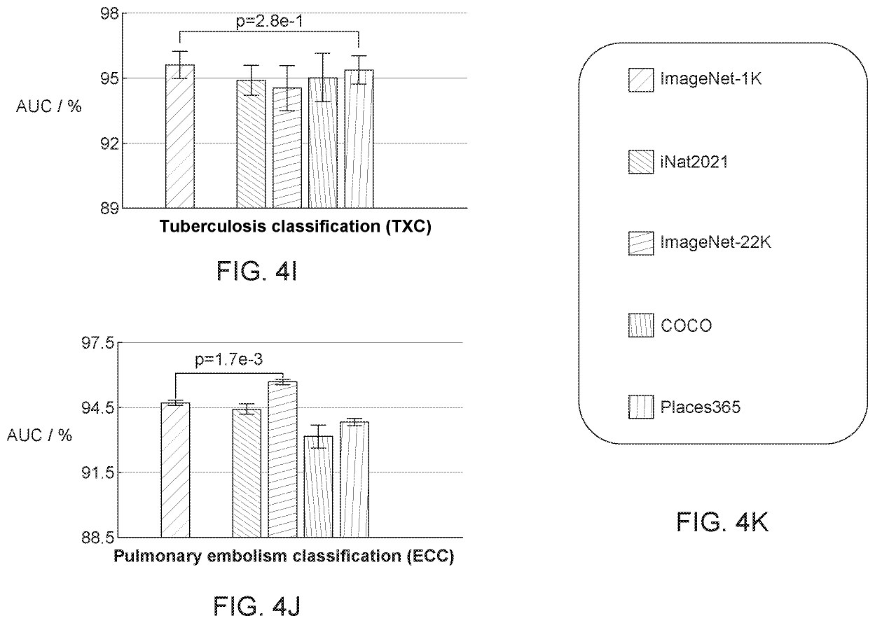

Question 3: What advantages can fine-grained data offer for pretraining models in transfer learning for medical imaging compared with coarse-grained data? The existing medical imaging literature mostly focuses on pretrained models using the ImageNet-1K dataset which was created for coarse-grained object classification. However, the potential advantages of utilizing pretrained models with large-scale fine-grained datasets for transfer learning in medical imaging remain largely unexplored. To bridge this gap, an extensive study (approximately 500 experiments) was conducted to assess the effectiveness of four fine-grained datasets: iNat2021, ImageNet-22K, Places365, and COCO, as pretraining sources for myriad medical imaging tasks. The findings reveal that pretrained models on datasets with finer data granularity and greater diversity yield more distinctive local representations, crucial for medical imaging tasks that are reliant on recognition of small, local variations in texture to detect/segment lesions and organs. FIGS. 4A-4K show that fine-tuning the models pretrained on large-scale finer grained datasets (FIG. 4K), namely iNat2021, ImageNet-22K, COCO, and Places365, offers a promising alternative to the de facto ImageNet-1K pretrained model for fine-grained medical applications. As seen, all fine-grained models consistently outperform the ImageNet-1K model across all six semantic segmentation tasks. Moreover, the top-performing fine-grained models excel in ECC (FIG. 4J) and DXC (FIG. 4G) classification tasks, while performing on par with the ImageNet-1K model in TXC (FIG. 4I) and DXC14 (FIG. 4H) classification tasks. These results highlight that pretrained models on fine-grained data capture subtle features that empower fine-grained medical imaging tasks.

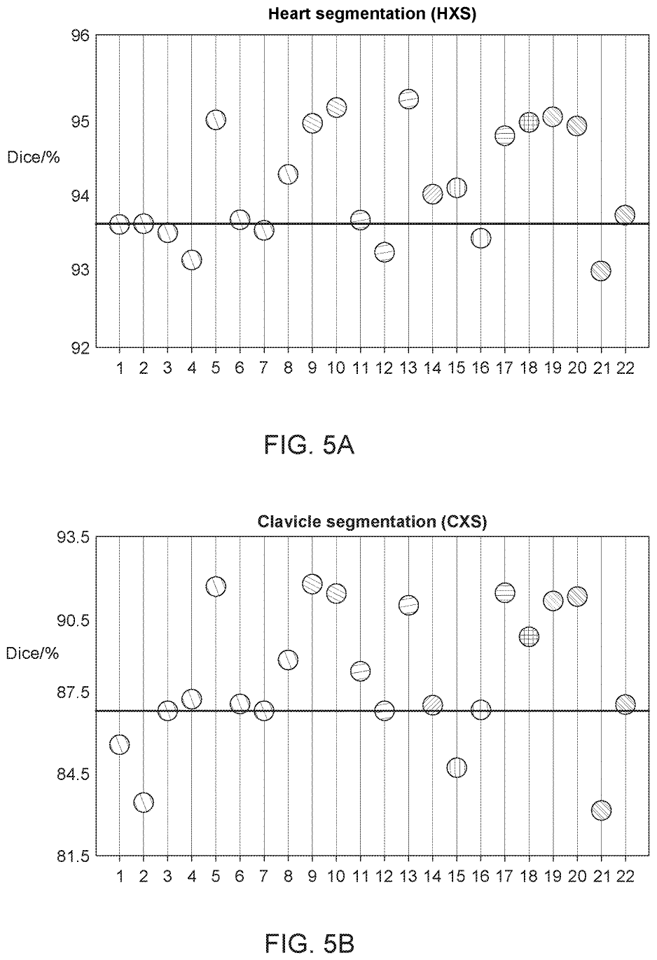

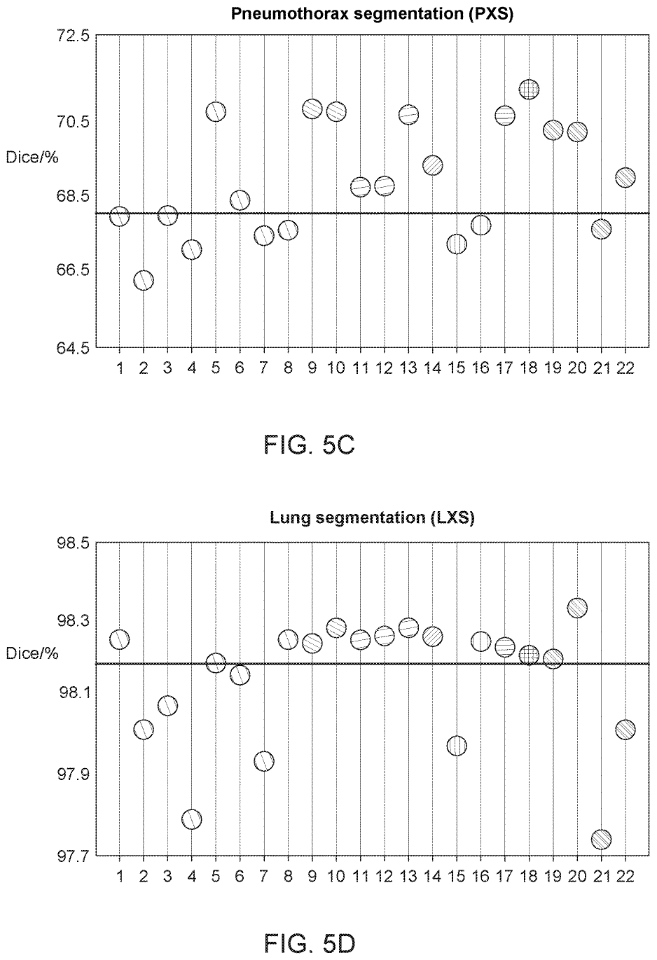

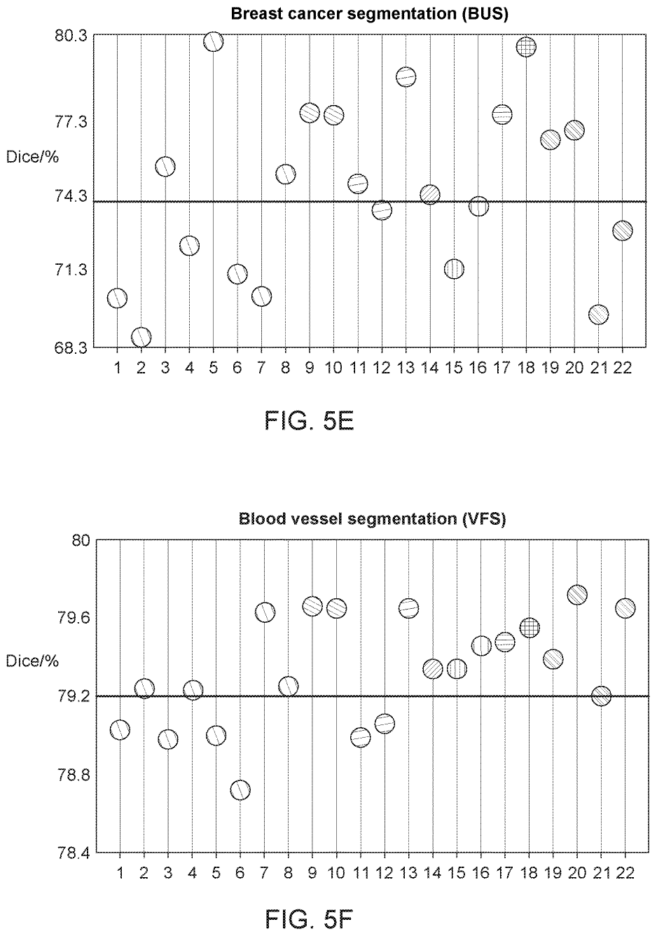

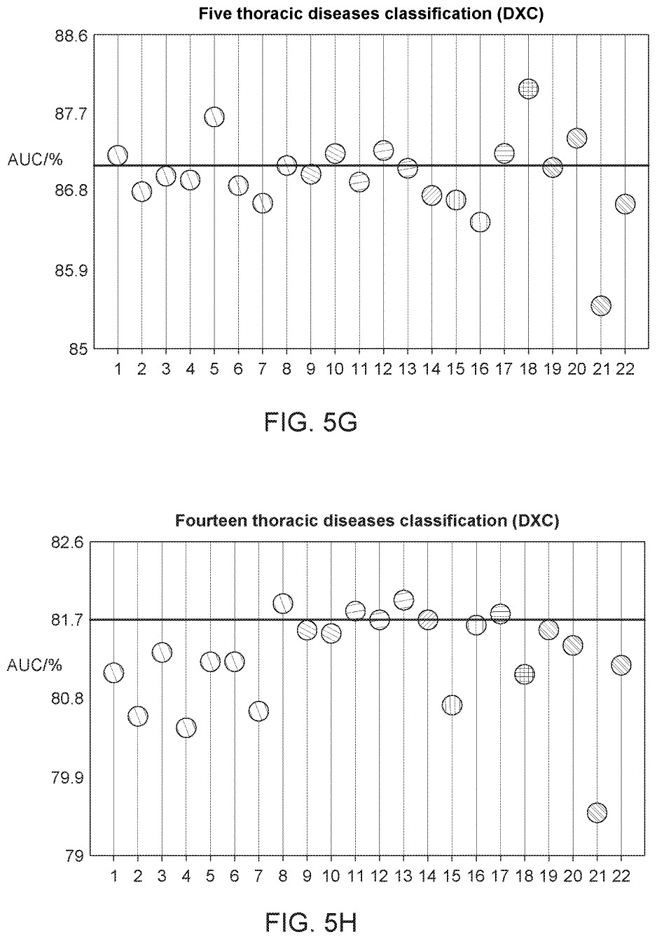

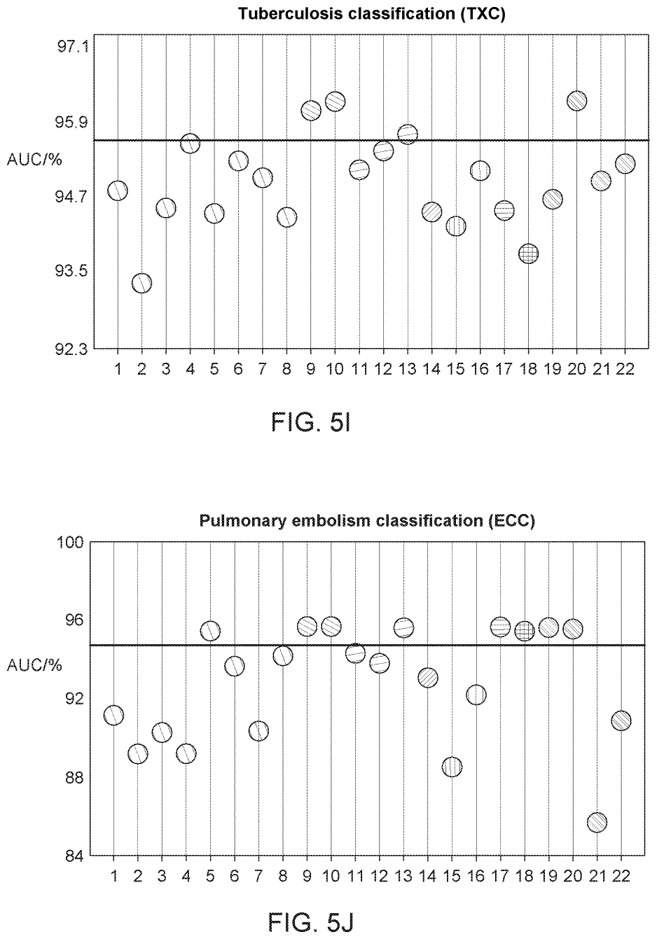

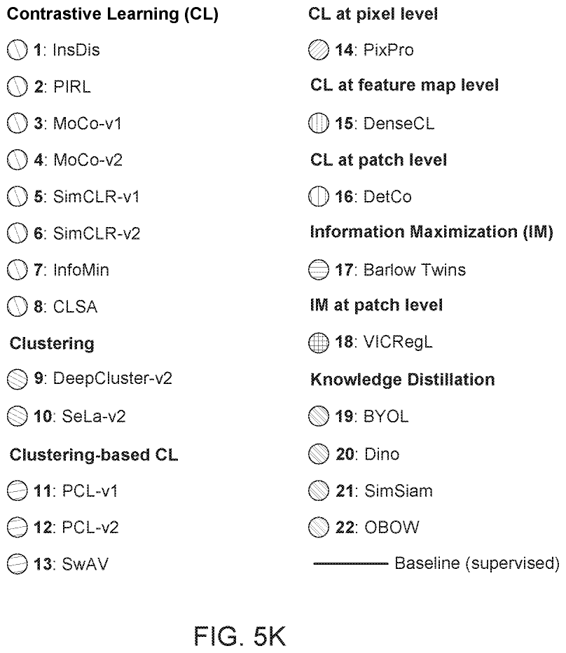

Question 4: How generalizable are the self-supervised ImageNet models to medical imaging tasks compared with supervised ImageNet models? The ongoing rapid advancements in self-supervised learning (SSL) have led to the development of newly established self-supervised ImageNet models that outperform gold standard supervised ImageNet models in various computer vision tasks. Despite the public availability of many SOTA self-supervised ImageNet models, there is a lack of a large-scale, up-to-date evaluation of these models when applied to diverse medical imaging tasks. To bridge this gap, an in-depth benchmark (approximately 2,000 experiments) was conducted to evaluate the efficacy of 22 recent self-supervised methods with diverse training objectives across numerous medical applications with various modalities, including X-ray, Ultrasound, CT, and fundoscopy images. The findings reveal that self-supervised ImageNet models learn holistic features more effectively than supervised ImageNet models, yielding higher generalizability in medical imaging tasks. FIGS. 5A-5K show that self-supervised learners can capture holistic features more effectively than their supervised counterparts, resulting in more generalizable representations for a variety of medical imaging tasks. As seen, most self-supervised ImageNet models outperform supervised models in terms of mean performance across at least three target tasks. This underscores the greater transferability of self-supervised representation learning. Notably, recent approaches such as DINO, SwAV, Barlow Twins, SeLa-v2, and DeepCluster-v2 consistently outperform the supervised ImageNet model in almost all target tasks. For ease of reference, each of the 22 self-supervised methods is now categorized into nine groups (FIG. 5K), with each group represented by a distinct set of dots in the plots. The methods are listed in numerical order from left to right.

How can readily accessible expert annotations associated with medical datasets enhance ImageNet models' capability to capture domain-relevant semantic information? Pretrained ImageNet models serve as the prevailing standard for transfer learning in medical imaging. However, the inherent disparities between photographic and medical images, alongside differences in recognition tasks between ImageNet and medical datasets, hinder ImageNet models from effectively capturing essential semantic features relevant to diseases and organs for medical recognition tasks. This constraint motivates a practical approach that tailors ImageNet models to medical applications. Towards this end, the effectiveness of domain-adaptive pretraining, originally developed in natural language processing, is considered for both photographic and medical datasets. Various domain-adapted models were developed using SOTA vision transformer and ConvNet architectures and extensively evaluated over a wide range of medical imaging tasks (approximately 400 experiments). The findings reveal that domain-adapted models harness knowledge acquired from ImageNet and enhance it by incorporating readily conducted annotation efforts derived from medical datasets, leading to the development of more performant models.

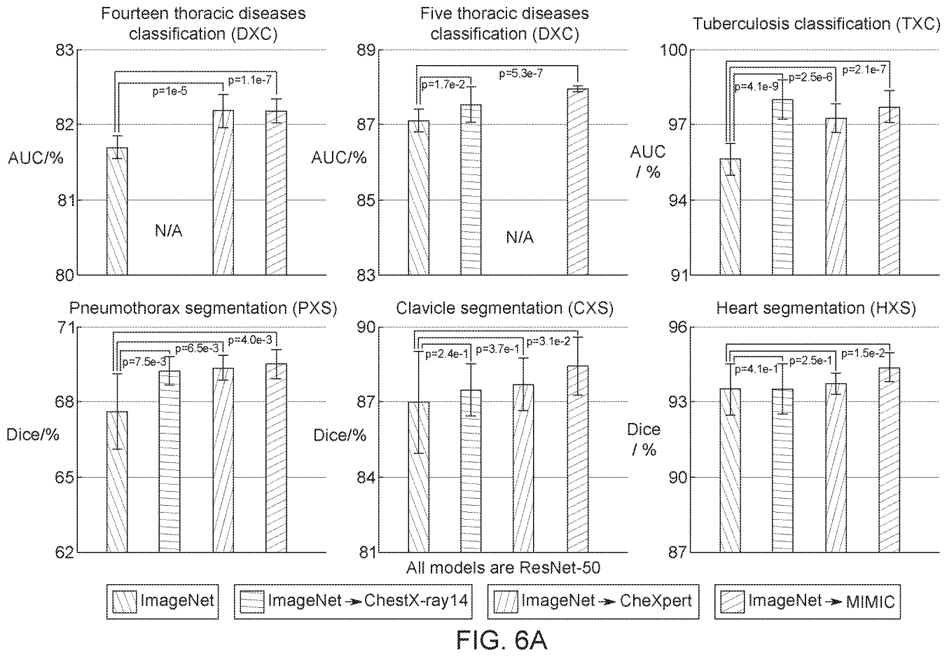

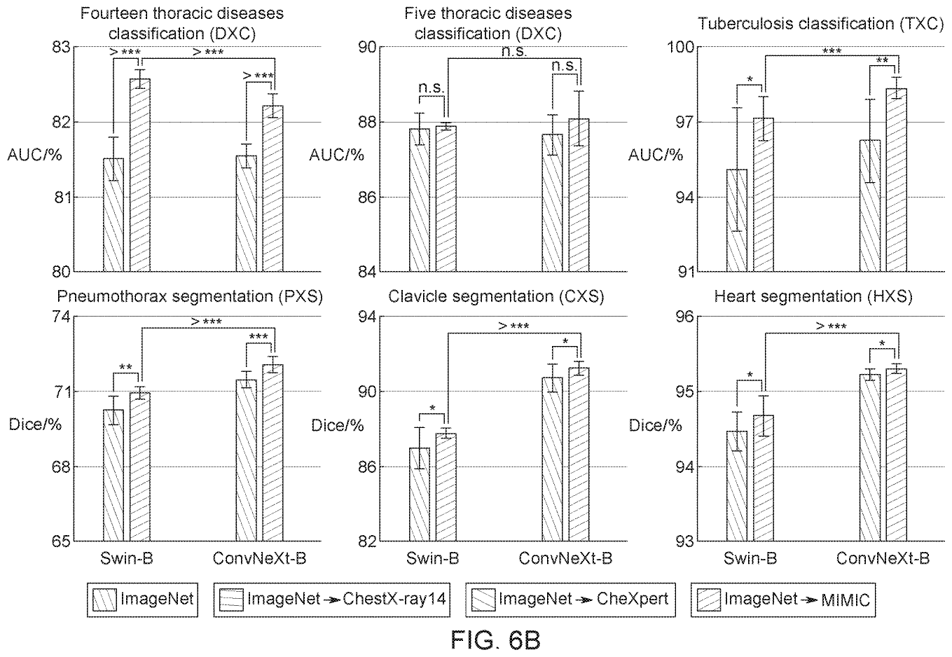

FIG. 6A shows that domain-adaptive pretraining serves as a vital bridge between the photographic and medical imaging domains, leading to improved performance compared with the standard ImageNet pretraining in all target tasks. Particularly, ImageNet→ChestX-ray14 and ImageNet→CheXpert domain-adapted models exhibit significantly better performance (p<0.05) compared with the standard ImageNet pretrained model in DXC1, DXC, TXC, and PXS, and comparable performance in CXS and HXS target tasks. Furthermore, increasing the amount of in-domain data through the utilization of the MIMIC-CXR dataset results in significant gaps (p<0.05) between domain-adapted (ImageNet→MIMIC) and ImageNet models in all target tasks, highlighting the crucial role of the data scale in effectively bridging the gap between photographic and medical images. FIG. 6B shows that domain-adaptive pretraining can boost the performance of ImageNet models with modern ConvNet (i.e., ConvNeXt-B) and vision transformer (i.e., Swin-B) backbones. Particularly, the ImageNet→MIMIC domain-adapted models with ConvNeXt-B and Swin-B backbones consistently demonstrate superior performance (p<0.05) compared with their corresponding ImageNet counterparts. Moreover, comparing ImageNet→MIMIC domain-adapted models with ConvNeXt-B and Swin-B backbones, the former exhibits superior performance in target tasks with relatively smaller datasets (TXC, PXS, CXS, and HXS), while the latter demonstrate equivalent or superior performance in target tasks with larger datasets (DXC and DXC), reiterating the superior annotation efficiency of pretrained models with ConvNets compared with those with vision transformer backbones.

Summary: A fine-grained and up-to-date study on the transferability of various brand-new pretraining techniques for medical imaging tasks is provided, answering central and timely questions on transfer learning in medical image analysis. The key findings from a broad systematic study (approximately 5,000 experiments) are as follows:
1. ConvNeXt variants compete favorably against their Swin counterparts in both transfer learning and in training from scratch settings, emphasizing the continued relevance and effectiveness of ConvNets in medical imaging.
2. ConvNets exhibit greater annotation efficiency than vision transformers when fine-tuned for medical imaging tasks, yet vision transformers have the potential to surpass ConvNets when substantial data is available for fine-tuning.
3. Fine-grained pretrained models outperform the coarse-grained supervised ImageNet model, offering a viable alternative for transfer learning in fine-grained medical tasks.
4. Self-supervised learning approaches excel in capturing holistic features effectively, leading to higher transferability compared with supervised approaches across diverse medical imaging tasks.
5. A domain adaptive pretraining approach according to the disclosed embodiments can harness knowledge acquired from ImageNet and enhance it by utilization of readily accessible expert annotations associated with medical datasets, leading to the development of more performant models with domain-relevant information in their learned embeddings.

This large-scale open evaluation of transfer learning can direct the future research of deep learning for medical imaging.

### 3. REPRESENTING PART-WHOLE HIERARCHIES IN FOUNDATION MODELS BY LEARNING LOCALIZABILITY, COMPOSABILITY, AND DECOMPOSABILITY FROM ANATOMY VIA SELF-SUPERVISION

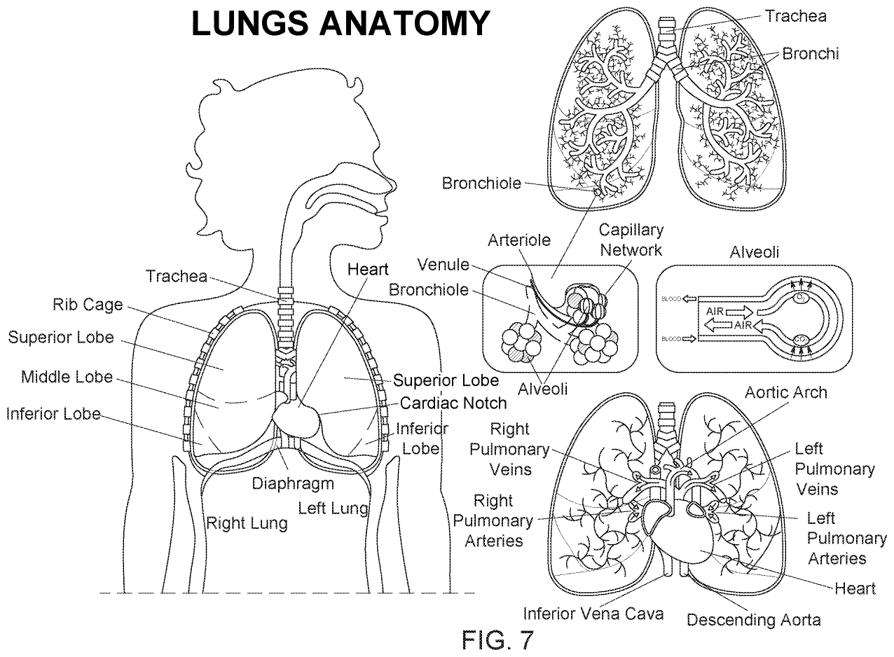

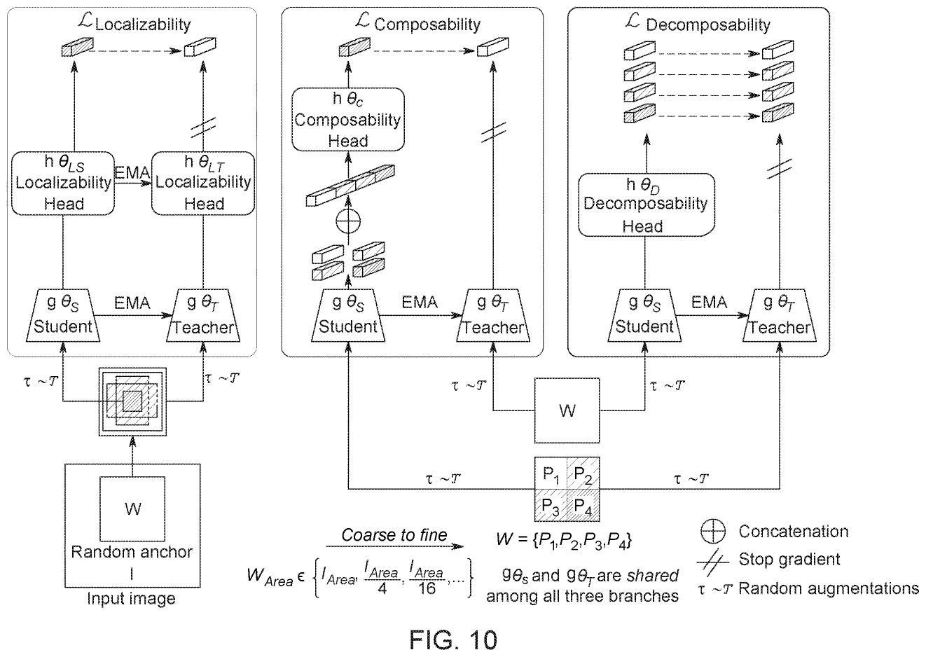

Human anatomy exhibits natural hierarchies. For example, the lungs are divided into the right and left lungs as illustrated in FIG. 7, and each lung is further divided into lobes, two on the left and three on the right lung. Each lobe is further subdivided into segments, each containing pulmonary arteries, veins, and bronchi which branch in predictable, dichotomous fashion. Consequently, anatomical structures have two important properties: (1) locality: each anatomical structure is morphologically distinct from others; and (2) compositionality & decompositionality: each anatomical structure is an integrated part of a larger whole, and vice versa, each anatomical structure (i.e., whole) can be broken down into its smaller constituent parts. FIG. 7 illustrates that human anatomy exhibits natural hierarchies. For example, lungs are divided into right and left lungs, each with lobes. The right lung has three lobes: superior, middle, and inferior; the left lung has two lobes: superior and inferior. The pulmonary arteries, veins, and airways form hierarchical trees. These anatomy hierarchies inspire a self-supervised learning (SSL) framework (see FIG. 10) that explicitly learns to encapsulate the intrinsic attributes of anatomical structures: locality and compositionality/decompositionality, within the embedding space, needed for anatomy understanding, yet overlooked in existing SSL methods, according to the disclosed embodiments.

Deep learning has facilitated significant advancements in learning visual representations at multiple levels. However, the multi-level feature space learned by deep models does not explicitly encode part-whole hierarchies with the necessary semantic information to denote hierarchical relationships between wholes and their constituent parts. To highlight the importance of explicitly representing part-whole hierarchies in neural networks, a proposed hypothetical system, GLOM, emulates human perception via parsing images into part-whole hierarchies.

Inspired by the conceptual idea underlying GLOM, the disclosed embodiments provide a novel self-supervised learning (SSL) framework, leading to a functioning system that, from medical images, autodidactically constructs a hierarchy of embeddings for distinct anatomical structures, semantically balancing anatomical diversity and harmony at each level and conveying parental “whole” at the higher level and filial “parts” at the lower level. The framework, as illustrated in FIG. 10, comprises three branches: (1) “localizability”, which compels the model to learn a semantically structured embedding space by discriminating between different anatomical structures, (2) “composability”, which empowers the model to learn part-whole relations by constructing each anatomical structure through the integration of its constituent parts, and (3) “decomposability”, which encourages the model to learn whole-part relations by decomposing each anatomical structure into its constituent parts. Unifying these three branches together in a coarse-to-fine learning approach, the localizability branch enables the model to preserve harmony in embeddings of semantically similar anatomical structures in a hierarchy of scales. Simultaneously, composability and decomposability branches empower the model to not only convey hierarchical relationships but also preserve diversity of semantically similar anatomical structures across patients through encoding finer-grained anatomical information of their constituent parts.

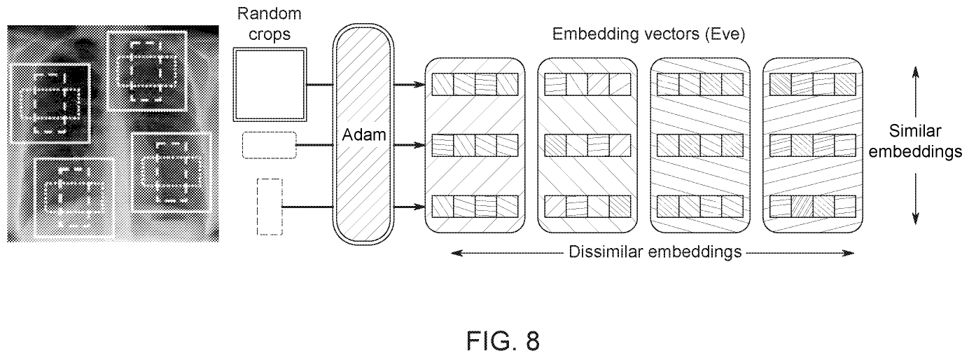

The disclosed embodiments (i.e., pretrained models), referred to herein as Adam-v2, are a notable improvement over the previous version, referred to as Adam (autodidactic dense anatomical models) version 1 (Adam-v1), which learns autodidactically and produces dense anatomical embeddings, also known as Eve (embedding vectors) for its semantic richness as illustrated in FIG. 8. FIG. 8 shows that existing SSL methods lack capabilities of “understanding” the foundation of medical imaging, that is, human anatomy. A foundation model must be able to transform each pixel in an image (e.g., chest radiographs) into semantics-rich numerical vectors, called embeddings, where different anatomical structures (indicated by differently shaded boxes) are associated with different embeddings, and the same anatomical structures have the same or nearly identical embeddings at all resolutions and scales (indicated by different box shapes) across patients. Inspired by the hierarchical nature of human anatomy (see FIG. 7), a novel SSL strategy is disclosed that learns anatomy from medical images, resulting in embeddings (Eve), generated by the pretrained model (Adam), with such desired properties. In the following sections, Adam-v1 is discussed first, followed by a detailed discussion of Adam-v2.

### Adam-v1 Framework

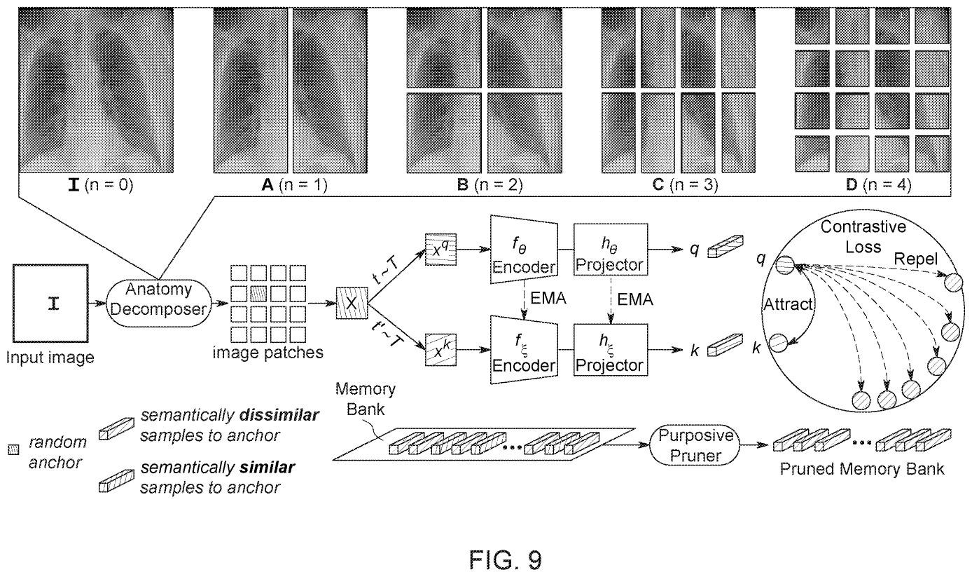

Adam-v1, depicted in FIG. 9, aims to exploit the hierarchical nature of human anatomy to capture not only generic but also semantically meaningful representations. FIG. 9 illustrates an SSL strategy that gradually decomposes and perceives anatomy in a coarse-to-fine manner. An Anatomy Decomposer (AD) decomposes the anatomy into a hierarchy of parts with granularity level n∈{0, 1, . . . } at each training stage. Thus, anatomical structures of finer-grained granularity will be incrementally presented to the model as the input. An image I is passed to the AD to get a random anchor x. x is augmented to generate two views (positive samples) that are then passed to two encoders to get their features. To avoid semantic collision in training objective, a purposive pruner removes semantically similar anatomical structures across images to anchor x from the memory bank. Contrastive loss is then calculated using positive samples' features and the pruned memory bank. The figure shows pretraining at n=4. The main intuition behind this learning strategy is the principle of totality in Gestalt psychology: humans commonly first recognize the prominent objects in an image (e.g., lungs) and then gradually recognize smaller details based on prior knowledge about that object (e.g., each lung is divided into lobes). Inspired by this principle, Adam-v1 provides a self-supervised training strategy that decomposes and perceives the anatomy progressively in a coarse-to-fine manner, aiming to learn both anatomical (local and global) contextual information and the relative hierarchical relationships among anatomical structures. Adam-v1 is comprised of two key components:

Anatomy Decomposer (AD) is responsible for decomposing relevant anatomy into a hierarchy of anatomical structures to guide the model to learn hierarchical anatomical relationships in images. The AD component takes two inputs: an image I and an anatomy granularity level n and generates a random anatomical structure instance x. Anatomical structures are generated at desired granularity level n in a recursive manner. An image I is first split vertically into two halves (A in FIG. 9). The process iteratively alternates between horizontally and vertically splitting the resulting image parts until the desired granularity level is reached (B, C, D in FIG. 9). This process results in 2ⁿ image patches

$${\{ x {i}_{i} \}}_{i = 1}^{{2}^{n}} .$$

In this set, an instance x is randomly sampled, which will be used as the input for training the model. As such, during the pretraining, anatomical structures at various granular levels are generated and present to the model.

Purposive Pruner (PP) is responsible for compelling the model to comprehend anatomy more effectively via learning a wider range of distinct anatomical structures. Intuitively, similar anatomical structures (e.g., ribs or disks) should have similar embeddings, while also their finer-grained constituent parts (e.g., different ribs or disks) have (slightly) different embeddings. To achieve such desired embedding space, the anatomical structures need to be intelligently contrasted from each other. The PP module, in contrast to standard contrastive learning approaches, identifies semantically similar anatomical structures in the embedding space and prevents them from being undesirably repelled. Given an anchor anatomical structure x randomly sampled from image I, the cosine similarities between features of x and the ones of the points in the memory bank are computed, and the samples with a similarity greater than a threshold γ are removed from the memory bank. Thus, the PP prevents semantic collision, yielding a more optimal embedding space where similar anatomical structures are grouped together while distinguished from dissimilar anatomical structures.

Overall training. The framework consists of two twin backbones f_{θ} and f_{ξ}, and projection heads h_{θ} and h_{ξ}. f_{θ} and h_{θ} are updated by back-propagation, while f_{ξ} and h_{ξ} are updated by exponential moving average (EMA) of f_{θ} and h_{θ} parameters, respectively. A memory bank is used to store the embeddings of negative samples

$$MB = \{ {k}_{i} \} {K}_{i = 1}^{K} ,$$

where K is the memory bank size. For learning anatomy in a coarse-to-fine manner, the anatomical structure granularity is progressively increased. Thus, at each training stage, anatomical structures with granularity level n∈{0, 1, . . . } will be presented to the model. Input image I and data granularity level n are passed to the AD to get a random anatomical structure x. An augmentation function T (⋅) is applied on x to generate two views x_{q} and xₖ, which are then processed by backbones and projection heads to generate latent features q=h_{θ}(f_{θ}(x_{q})) and k=h_{ξ}(f_{ξ}(xₖ)). Then, q and MB are passed to the PP to remove false negative samples for anchor x, resulting in pruned memory bank MB_{pruned}, which is used to compute the InfoNCE loss:

$$ℒ = - log \frac{exp ( q \cdot k / τ )}{exp ( q \cdot k / τ ) + {\sum }_{i = 1}^{{K}^{′}} exp ( q \cdot {k}_{i} / τ )} \qquad ( 4.1 )$$

where τ is a temperature hyperparameter, K′ is size of MB_{pruned}, and kᵢ∈MB_{pruned}. The AD module enables the model to first learn anatomy at a coarser-grained level, and then uses this acquired knowledge as effective contextual clues for learning more fine-grained anatomical structures, reflecting anatomical structures compositionality in its embedding space. The PP module enables the model to learn a semantically structured embedding space that preserves anatomical structure locality by removing semantic collision from the model's learning objective. The pretrained model derived by this training strategy (Adam-v1) can not only be used as a basis for myriad target tasks via adaptation (fine-tuning), but also its embedding vectors (Eve-v1) show promises to be used standalone without adaptation for other tasks like landmark detection.

### Adam-v2 Framework

The disclosed embodiments, a self-supervised framework referred to herein as Adam-v2, are depicted in FIG. 10. Adam-v2 seeks to underpin the development of powerful self-supervised models foundational to medical imaging by exploiting the hierarchical nature of anatomy. FIG. 10 illustrates that the self-supervised learning framework constructs a hierarchy of embeddings that can be autodidactically learned from anatomy and that can enhance the generalizability and robustness of representation learning. Adam-v2 learns hierarchical representations in a coarse-to-fine-manner via explicitly incorporating part-whole hierarchies into its learning objectives through three key branches: localizability, composability, and decomposability. Given an anchor whole w randomly sampled from image I, the localizability branch augments and processes w and its multi-scale views, and enforces consistency between their embeddings, yielding distinct features for different anatomical structures. The composability branch decomposes w into a set of parts and enforces consistency between the embeddings of w and the aggregated embeddings of its parts, encoding part-whole relations. The decomposability branch decomposes the embeddings of w to acquire the embeddings of its constituent parts and enforce consistency between the embeddings of parts and their decomposed counterparts, capturing whole-part relations. Through the seamless integration of these learning objectives into a unified framework, Adam-v2 preserves a semantic balance of anatomical diversity and harmony within its learned embedding space, yielding representations that are both generic and semantically meaningful, yet disregarded in existing SSL methods.

While the earlier method Adam-v1 uses anatomy hierarchies as soft supervisory signals, Adam-v2 explicitly captures part-whole hierarchies via its learning objectives. Compared with Adam-v1, Adam-v2 offers two significant advancements: (i) enhancing the localizability branch by eliminating negative pairs, thereby improving computational efficiency for large-scale pretraining, (ii) introducing two novel components: composability and decomposability, which are used for capturing part-whole hierarchies. Particularly, Adam-v2 comprises three key branches: (1) localizability which acquires discriminative representations for distinguishing different anatomical structures; (2) composability which learns each anatomical structure in a parts-to-whole manner; and (3) decomposability comprehends each anatomical structure in a whole-to-parts manner. Seamlessly integrating these learning objectives into a unified framework constructs a hierarchy of embeddings from anatomy that can enhance the generalizability and robustness of representation learning. The following discussion details each branch of the framework, followed by an outline of the training pipeline.

Localizability branch-acquiring discriminative representations to distinguish different anatomical structures. The localizability branch aims to learn a semantically structured embedding space where similar anatomical structures are clustered together and are distinguished from dissimilar anatomical structures. As shown in FIG. 10, the localizability branch includes the student g_{θ}_{_{S}} and teacher ger encoders, and two projectors h_{θ}_{_{LS}} and h_{θ}_{_{LT}}, referred to as localizability heads. The student and teacher networks share the same architecture. The parameters of student g_{θ}_{_{S}} and localizability head h_{θ}_{_{LS}} are optimized with stochastic gradient descent while the parameters of the teacher g_{θ}_{_{T}} and head h_{θ}_{_{LT}} are updated using an exponential moving average (EMA) on the weights of g_{θ}_{_{S}} and h_{θ}_{_{LS}}, respectively. Given an anchor patch w randomly sampled from the input image I, a set C of multi-scale crops are extracted from w. These crops exhibit diverse dimensions yet maintain either the same or slightly shifted center as w, enriching the understanding of a single anatomical structure across various resolutions. Subsequently, random data augmentations T(⋅) are applied on w and multi-scale crops in C. The augmented view of w is passed to the teacher, while the augmented views of the crops in C are passed to the student network, generating the features yₜ=g_{θ}_{_{T}}(T(w)) and Yₛ={g_{θ}_{_{S}}(T(c))|c∈C}, respectively. The localizability heads are employed to project the features produced by the teacher and student networks to the output embeddings zₜ=h_{θ}_{_{LT}}(yₜ) and Zₛ={h_{θ}_{_{LS}}(yₛ)|yₛ∈Yₛ}, which are normalized with a softmax function:

$${{P}_{i} ( {z}_{t} )}^{( i )} = \frac{exp ( {z}_{t}^{( i )} / {τ}_{t} )}{{\sum }_{k = 1}^{K} exp ( {z}_{t}^{( k )} / {τ}_{t} )} \qquad ( 4.2 )$$

where τₜ>0 is a temperature parameter controlling the sharpness of the teacher's output distribution, and K is the output dimension of the localizability heads. A softmax function Pₛ with temperature τₛ is similarly employed to normalize the features in Zₛ. The localizability branch's objective is to maximize the consistency between the embedding vectors of the input anchor and its augmented views. To do so, cross-entropy loss is employed to train the localizability branch:

$${ℒ}_{Localizability} = - \frac{1}{\vert {Z}_{s} \vert} {\sum }_{{z}_{s} ∈ {Z}_{s}} {P}_{t} ( {z}_{t} ) log {P}_{s} ( {z}_{s} ) \qquad ( 4.3 )$$

Notably, the framework provides flexibility in utilizing various localizability loss functions. Self-distillation loss is used due to its simplicity and efficiency. Alternative objectives, like contrastive loss, can also be employed.

$${ℒ}_{Composability} = {ℓ}_{s} ( {z}_{wt} , {z}_{p s} ) \qquad ( 4.4 )$$

where lₛ(z_{wt}, zₚₛ) presents a function that measures similarity between z_{wt} and zₚₛ, such as MSE, cross-entropy, or cosine similarity.

Composability branch—encoding the semantics of part-whole relations from anatomical structures. The composability branch aims to learn the part-whole anatomical hierarchies in a bottom-up manner by assembling larger anatomical structures from their smaller constituent subparts. As shown in FIG. 10, the composability branch consists of the student g_{θ}_{_{S}} and teacher g_{θ}_{_{T}} encoders, which are shared with the localizability branch, and a composability head h_{θ}_{_{C}}. An anchor whole w randomly sampled from the input image I is decomposed into a set of n non-overlapping parts

$$P = {\{ {p}_{i} \}}_{i = 1}^{n} .$$

The parts are augmented and processed by the student network, generating parts' embeddings

$${Y}_{p s} = {\{ {y}_{l} = {g}_{{θ}_{S}} ( T ( {p}_{i} ) ) \}}_{i = 1}^{n} .$$

The parts' embeddings are then concatenated and passed to the composability head h_{θ}_{_{C}} to produce the aggregated embeddings of parts

$${z}_{p s} = {h}_{{θ}_{C}} ( ⊕ ( {\{ {y}_{i} \}}_{i = 1}^{n} ) ) .$$

The whole anatomical structure w undergoes augmentation and is then passed to the teacher network to generate its corresponding embedding z_{wt}=g_{θ}_{_{T}}(T(w)). The composability branch is trained to maximize the agreement between the whole's embedding and the aggregated embeddings of its parts:

$${ℒ}_{Composability} = {ℓ}_{s} ( {z}_{wt} , {z}_{p s} ) \qquad ( 4.4 )$$

where lₛ(z_{wt}, zₚₛ) presents a function that measures similarity between z_{wt} and zₚₛ, such as MSE, cross-entropy, or cosine similarity.

Decomposability branch—capturing the semantics of whole-parts relations from anatomical structures. The decomposability branch aims to learn the whole-part anatomical hierarchies in a top-down manner by decomposing larger anatomical structures into their smaller constituent subparts. As shown in FIG. 10, the decomposability branch comprises the student g_{θ}_{_{S}} and teacher g_{θ}_{_{T}} encoders, which are shared with the localizability and composability branches, and a decomposability head h_{θ}_{_{D}}. An anchor whole w randomly sampled from the input image I is decomposed into a set of n non-overlapping parts

$$P = {\{ {p}_{i} \}}_{i = 1}^{n} .$$

The anchor whole w is augmented and fed into the student network, producing the whole's embedding z_{ws}=g_{θ}_{_{S}}(T(w)). The whole's embedding is then passed to the decomposability head h_{θ}_{_{D}}, which decomposes it into a set of individual embeddings corresponding to the constituent parts of the whole zₚₛ=h_{θ}_{_{D}}(z_{ws}). Additionally, the parts

$$P = {\{ {p}_{i} \}}_{i = 1}^{n}$$

are augmented and processed by the teacher network, generating parts' embeddings

$${Z}_{p t} = {\{ {g}_{{θ}_{T}} ( T ( {p}_{i} ) ) \}}_{i = 1}^{n} .$$

The decomposability branch is trained to maximize the agreement between embeddings of individual parts and their decomposed counterparts:

$${ℒ}_{Decomposability} = \frac{1}{\vert P \vert} {\sum }_{i = 1}^{\vert P \vert} {ℓ}_{s} ( {z}_{{p}_{i}} , {z}_{{p}_{i}^{′}} ) \qquad ( 4.5 )$$

where zₚᵢ∈Zₚₜ and z_{p′}_{ᵢ}∈Zₚₛ, and lₛ(zₚᵢ, z_{p′}_{ᵢ}) presents a function that measures similarity between zₚᵢ and z_{p′}_{ᵢ}, such as MSE, cross-entropy, or cosine similarity

Training Pipeline. To guide the model in learning hierarchical representations, a hierarchy of diverse anatomical structures at various scales is used. Specifically, the highest level of the hierarchy represents entire images (of spatial resolution (H×W)) with complete anatomy, while each subsequent level m∈{1, 2 . . . } represents anatomical structures w at a scale of

$$( \frac{H}{{2}^{m}} \times \frac{W}{{2}^{m}} ) ,$$

randomly sampled from the images. In a coarse-to-fine manner, the anatomical structures w at each level are fed as the input to the localizability, composability, and decomposability branches, and are learned through the following loss function:

$$ℒ = {λ}_{1} * {ℒ}_{Localizability} + {λ}_{2} * {ℒ}_{Composability} + {λ}_{3} * {ℒ}_{Decomposability} \qquad ( 4.6 )$$

where λ₁, λ₂, λ₃ are coefficients denoting the weight of each loss term. Through the unified training scheme, a rich embedding space is learned, preserving harmony among similar anatomical structures and encoding their hierarchical relations. In particular, the localizability loss term encourages the model to capture distinctive embeddings for different anatomical structures across varying scales. Moreover, the composability and decomposability loss terms empower the model with a profound understanding of the part-whole relations in both bottom-up and top-down manners.

Extensive experiments showcase Adam-v2's advanced capability in anatomy understanding, unveiled through its embeddings (Eve-v2). Particularly, Eve-v2 demonstrates a zero-shot understanding of anatomy as revealed through its learned properties: (i) preserving localizability of anatomical structures and (ii) encoding part-whole relations of anatomical structures as well as its emergent properties: (iii) understanding anatomical layouts via interpolation and extrapolation, (iv) associating each image pixel with (dense) semantic embeddings, (v) recognizing anatomical symmetries, (vi) generating embeddings consistent across scales, and (vii) matching anatomical structures across images of the same patient with different diseases, images of different patients, and augmented views of the same image. Adam-v2 also offers robust and generalizable representations and stands out in few-shot and full-transfer learning.

### 4. DEVELOPING A COMPREHENSIVE TEST SUITE FOR ANALYZING FOUNDATION MODELS IN MEDICAL IMAGING

The rapid emergence of foundation models in AI has signaled transformative potential across various domains, including medical imaging. While several foundation models have recently been developed for this field, their capabilities and effectiveness, particularly from medical and clinical perspectives, remain largely unexplored. Understanding what works and what does not in the context of medical imaging is critical for providing actionable insights into their integration into clinical workflows and advancing medical imaging research and practice. To address this need, a comprehensive test suite is used to systematically evaluate recently developed anatomical foundation models (LeADER, Adam-v2, PEAC, ACE, Lamps, RAD-DINO, CheSS, and EVA-X) across multiple dimensions relevant to medical imaging, focusing on the following research questions:

Question 1: Can anatomical foundation models detect anomalies in medical images? Anomaly detection is the process of identifying unusual patterns within medical images that differ from those found in normal or healthy samples, potentially indicating the presence of diseases or abnormalities. Anomaly detection serves as a critical first-line task in medical imaging, facilitating the early identification of abnormalities without requiring an exhaustive list of predefined diseases. Existing foundation models in medical imaging have showcased remarkable capabilities for detecting specific abnormalities when fine-tuned with annotated data. However, acquiring diverse annotated datasets for various lesions is challenging, especially for rare or newly identified diseases, where low prevalence and limited prior knowledge hinder data collection. Anomaly detection provides a promising alternative for evaluating the capacity of foundation models to detect abnormal patterns, particularly rare or unseen conditions, in medical images, yet remains largely underexplored. To address this gap, a systematic study was conducted to assess the capability of recently developed foundation models to identify anomalies in medical images in few-shot and zero-shot (without fine-tuning) settings.

Experimental setup. Anomaly detection was evaluated in few-shot and zero-shot settings using ZhangLab Chest X-ray dataset (containing normal and pneumonia images), COVIDx dataset (with normal, pneumonia, and COVID-19 images), and CheXpert dataset (comprising normal images and images featuring 14 distinct pathologies). For few-shot evaluations, a small number of normal samples are used from each dataset's training set to fine-tune the pretrained models under study for identifying normal samples. Subsequently, the fine-tuned models are utilized to extract feature embeddings from normal training images. A Gaussian Density Estimator (GDE) is then employed to model the probability distribution of these embeddings, serving as a reference for detecting anomalies. At inference, embeddings for test images are extracted using the same fine-tuned models. Anomaly scores are computed by assessing how test embeddings align with the normal data distribution modeled by the GDE. Samples with higher anomaly scores, indicating significant deviation from the normal distribution, are flagged as potential anomalies. To evaluate performance, the Area Under the Curve (AUC) is computed using the anomaly scores and ground truth labels of the test images. For zero-shot evaluations, no normal samples are used to further tune the pretrained models; instead, the pretrained models are directly utilized to extract feature embeddings, with the remainder of the process following the few-shot setting.

Question 2: How effective are anatomical foundation models in segmenting organs and lesions with minimal annotated data? Organ and lesion segmentation is a fundamental task in medical imaging, playing a pivotal role in diagnosis, therapy, and surgical interventions for several life-threatening diseases. Various foundation models in medical imaging have demonstrated significant potential for precise segmentation of organs and lesions when fine-tuned with medium- or large-sized training datasets. However, their effectiveness in few-shot segmentation tasks—where models are fine-tuned using only a few annotated examples (e.g., 1-shot, 2-shot, 5-shot)—remains largely underexplored, leaving a significant gap in understanding their true potential in tasks with scarce annotated data. To address this gap, a systematic study was conducted to evaluate the capability of these models to segment organs and lesions (e.g., heart, lungs, spine disks, ribs, etc.) in few-shot settings.

Experimental setup. For organ segmentation tasks, heart, clavicle, spine disks, and ribs segmentation are considered using the JSRT dataset (for heart and clavicle) and PAX-Ray++ dataset (for spine disks and ribs), with each model fine-tuned on 3, 6, 12, and 24 shots randomly sampled, enabling a granular analysis of performance under varying annotation constraints. For lesion segmentation tasks, various thoracic diseases (e.g., pneumothorax, emphysema, and fibrosis) are examined, utilizing the SIIM-ACR and ChestX-Det datasets, with models fine-tuned on 5% and 10% of randomly selected labeled data, reflecting real-world scenarios where annotated data is often scarce. This experimental design aims to comprehensively assess each model's ability to generalize and adapt in segmentation tasks with minimal annotated data, providing critical insights into their robustness and efficiency.

Question 3: Can anatomical foundation models match anatomical structures of the same patient over time and across patients without task-specific training? Matching anatomical structures across patients is critical for various medical imaging tasks, such as identifying consistent patterns in health and disease to enable more personalized diagnostics and treatment plans. However, providing annotated data for anatomical structure matching is highly impractical due to the complexity, variability, and labor-intensive nature of medical data annotation. Zero-shot settings, relying solely on pretrained models without task-specific training, offer a promising alternative for evaluating the learned representations of foundation models. Yet the potential of recently developed foundation models in understanding anatomy, particularly in identifying similar structures of the same patient over time and across patients, remains largely unexplored. To address this gap, a systematic study was conducted to assess the ability of these models to match anatomical structures (e.g., spine disks, ribs, etc.) across patients in zero-shot settings.

Experimental setup. An anatomical landmark dataset is used to match diverse chest anatomical structures, as well as the PAX-Ray++ dataset to match spine disks and ribs across patients in chest X-ray images. For each anatomical structure, a query image is randomly selected and a patch centered on the corresponding anatomical structure is extracted. The query patch is resized to 2242 and passed through each pretrained model under the study to generate query embeddings. Then, for an unlabeled key image, a set of key patches is extracted by applying a sliding window across the image. These key patches are resized to 2242 pixels and passed through each pretrained model under the study to generate key embeddings. Finally, the l₂-distance between the query embeddings and all key embeddings is calculated and the center of the patch is identified corresponding to the embeddings with the minimum distance as the matched anatomical structure. Qualitative results showcase matched anatomical structure samples for each model, along with quantitative results by reporting prediction errors in terms of mean squared error (MSE) for each model.

Question 4: Can foundation models retrieve consistent anatomical patterns in health and disease without task-specific training? Retrieving consistent anatomical patterns across images, irrespective of disease presence, is crucial for enhancing diagnostic precision by identifying subtle deviations from healthy anatomical patterns and monitoring disease progression through comparative analysis-ultimately enabling personalized treatment strategies. However, providing annotated datasets for such retrieval tasks is often impractical due to the variability of medical conditions and the labor-intensive nature of labeling complex patterns. A foundation model capable of automatically retrieving such patterns across health and disease states would not only validate its inherent understanding of anatomy but also demonstrate its potential to operate without reliance on annotated data for these tasks. Despite the recent development of foundation models in medical imaging, their ability to perform such tasks in zero-shot settings remains largely unexamined. To address this gap, a systematic study was conducted to evaluate the capability of foundation models to retrieve patterns in health and disease across patients under two scenarios: (a) retrieving an arbitrary anatomical pattern (in health or disease) from a set of images (in health or disease), and (b) retrieving a disease-specific pattern from any location in a diseased image.

Experimental setup. For the first scenario, an anatomical pattern is extracted from a randomly selected test image (in health or disease), referred to as the query patch, and passed through the foundation models under study to derive its embedding. A sliding window is then applied to images in the training set to extract patches, which are processed through the foundation models to obtain their embeddings. Cosine similarity is computed between the embedding of the query patch and the embeddings of the patches extracted from the training set. The patch in each training image with the highest cosine similarity to the query patch is identified as the matched anatomical pattern. For the second scenario, a random diseased test image is selected, and a diseased patch is extracted, referred to as the disease query. The embeddings of the disease query and all training images in the dataset are derived using each foundation model under study. Cosine similarity is calculated between the embedding of the disease query and the embeddings of the training images. The training images are ranked based on their similarity to the disease query, and precision and recall scores are calculated for the retrieved images using the ground truth label for the disease query and the disease labels of the retrieved images.

Question 5: Can anatomical foundation models capture anatomical structure relationships in their embedding space? Understanding anatomical relationships is fundamental in medical imaging, as they uncover correlations between anatomical structures and support a wide range of diagnostic and interventional procedures. A foundation model capable of automatically capturing these relationships within its learned embedding space would demonstrate an intrinsic understanding of anatomy and the potential to leverage this knowledge for complex spatial reasoning tasks. However, the capacity of recently developed foundation models to perform such spatial reasoning in medical imaging remains largely unexamined. To address this gap, a systematic study was conducted to evaluate the capability of foundation models in zero-shot settings to: (a) distinguish instances of the same anatomical structure (e.g., spine disks, ribs) and (b) predict the location of a specified anatomical structure based on other structures.

Experimental setup. For distinguishing instances of the same anatomical structure, the PAX-Ray++ dataset is used, focusing on spine disks and ribs across patients in chest X-ray images. For each anatomical structure, patches containing instances of that structure are extracted from different patients. These patches are resized to 2242 and passed through each pretrained model under study to generate their embeddings. The embeddings are then visualized by projecting them onto a two-dimensional space using t-SNE. For predicting the embeddings of a specified anatomical structure based on other structures, a masked image modeling approach is used. From a given input image, K random anatomical landmarks are identified. Using their provided coordinates, patches covering these landmarks are extracted and passed through the foundation models under study to obtain their embeddings. These embeddings serve as input to a lightweight model, with a subset randomly masked. The model is trained to predict the embeddings of the masked landmarks, thereby learning to infer missing anatomical information by leveraging the spatial and relational cues encoded in the unmasked embeddings. During training, embeddings for 1 to K−1 landmarks are randomly masked at each stage. By progressively reducing the number of unmasked embeddings, the model is challenged to rely increasingly on its understanding of the spatial and structural relationships between anatomical landmarks. At inference, patches are similarly extracted around the coordinates of the K landmarks in the test set and passed through the foundation models under study to obtain their embeddings, which serve as the ground truth. Sequentially, 1 to K−1 landmarks are randomly masked, and the trained lightweight model predicts the embeddings of the masked landmarks. The similarity score between the predicted embeddings and the ground truth is computed. It is anticipated that the similarity score will improve as the number of unmasked embeddings increases, highlighting the model's reliance on spatial and relational information to accurately predict the masked embeddings.

Question 6: Can foundation models distinguish anatomical structures in zero- or few-shot settings? Effectively distinguishing anatomical structures in medical imaging may help clinicians navigate the complexities of organs, tissues, and pathological regions with precision, thereby supporting accurate diagnostics and tailored treatment planning. Due to the diversity of anatomical structures in medical images and the high cost and time-intensive nature of annotating them, training models for such tasks is often impractical. A foundation model capable of differentiating anatomical structures without extensive training or with minimal annotated data would demonstrate its inherent understanding of anatomy by capturing the distinctiveness of anatomical structures through its learned embeddings. However, whether existing foundation models can effectively achieve this level of differentiation and demonstrate robust understanding of anatomical structures remains largely underexplored. To address this gap, a systematic study was conducted to evaluate the capability of foundation models in distinguishing anatomical structures under zero- and few-shot settings, focusing on whether their learned embeddings result in well-separated clusters for different anatomical structures, thereby reflecting a robust understanding of anatomy.

Experimental setup. A dataset of 1,000 images (from the ChestX-ray14 dataset) is compiled, with 10 distinct anatomical landmarks manually marked by human experts in each image. This dataset is used to evaluate the ability of foundation models to distinguish different anatomical structures in chest X-rays. To further assess the ability of the foundation models under study to handle subtle variations in anatomical structures, the PAX-Ray++ dataset, which includes annotations for individual spine disks, is utilized to evaluate their capability to differentiate finer anatomical structures (e.g., distinguishing Disk 3 from Disks 2 and 4). For zero-shot evaluations, patches are extracted around the location of each landmark or disk across images, and latent features (i.e., embeddings) of each patch are derived using each pretrained model under study (without fine-tuning). The embeddings are visualized by projecting them onto a two-dimensional space using t-SNE. For few-shot evaluations, both the compiled chest landmark dataset and the PAX-Ray++ dataset are randomly split into training and testing sets. A linear classifier is trained on top of the embeddings extracted by each model, using 5 and 10 samples (shots) per class. The classifier's accuracy is then evaluated on the test set.

Question 7: How well can foundation models diagnose common lung diseases? Accurate diagnosis of prevalent lung diseases (e.g., pneumonia, tuberculosis) is critical in medical imaging, directly influencing patient outcomes by enabling timely detection and targeted interventions. Recent advancements in foundation models for medical imaging have demonstrated promising capabilities across various diagnostic tasks, including lung disease detection. Given the clinical significance of these tasks and the availability of public datasets sourced from hospitals—with diagnostic labels derived from radiology reports or provided by expert lung specialists—it is imperative to systematically benchmark these models under standardized settings. Such benchmarking can assess their effectiveness and reliability in diagnosing common lung diseases, offering insights into their potential for clinical integration and the advancement of thoracic disease diagnosis and treatment planning. To address this need, recently developed foundation models were systematically evaluated on common lung disease diagnosis tasks, examining their adaptability and performance in diagnostic setting, while providing valuable insights into their clinical relevance and utility.

Experimental setup. Several public chest X-ray datasets annotated for common lung diseases were used, including ChestX-ray14 (with labels for 14 thoracic diseases), VinDR-CXR (with labels for 6 thoracic findings), NODE21 (with labels for lung nodules), COVIDx (with labels for COVID-19 and Pneumonia), and TBX-11K (with labels for tuberculosis). The pretrained models under study were evaluated by fully fine-tuning each model for each respective task.

Question 8: How well can foundation models localize common lung diseases? Precisely pinpointing lung diseases like pneumonia, tuberculosis, and pulmonary nodules is crucial for directing specific treatments and improving the planning of medical interventions. While disease diagnosis focuses on determining the presence of a condition, disease localization aims to pinpoint the exact regions of interest (ROIs) affected by pathological changes, providing essential spatial context for informed clinical decision-making. Despite recent advancements in foundation models for medical imaging, their proficiency in localizing lung diseases remains less thoroughly investigated compared with their diagnostic strengths. Given the clinical significance of disease localization and the availability of public datasets sourced from hospitals accompanied by bounding box annotations, this study seeks to systematically benchmark foundation models under standardized settings for lung disease localization tasks. Such benchmarking enables an evaluation of their effectiveness in identifying pathological ROIs, offering insights into their potential utility in assisting radiologists with accurate and efficient disease localization. To address this need, recently developed models were systematically evaluated on lung disease localization tasks examining their adaptability and performance and offering practical insights into their clinical relevance and applications.

Experimental setup. The public chest X-ray datasets annotated with bounding box labels for common lung diseases, including VinDR-CXR (with labels for 14 thoracic diseases), ChestX-Det (with labels for 13 thoracic diseases), NODE21 (with labels for lung nodules), RSNA Pneumonia (with labels for pneumonia), and TBX-11K (with labels for tuberculosis) were used. The encoder of the localization model was initialized with each pretrained model under study and fully fine-tune the localization model for each respective task.

In summary, this comprehensive test suite aims to systematically evaluate the capabilities of recently developed foundation models across diverse medical imaging tasks, ranging from anomaly detection and anatomical structure analysis to disease diagnosis and localization. By addressing critical gaps in understanding their performance under various settings, this disclosure provides actionable insights into their adaptability, reliability, and potential clinical relevance.

### 5. CONCLUSION

Foundation models represent a transformative advancement in artificial intelligence, offering unparalleled adaptability across diverse tasks and holding significant promise for revolutionizing medical imaging. Despite their potential, the development of foundation models in medical imaging has been hindered by challenges such as the lack of efficient learning strategies and standardized evaluation frameworks, coupled with the unique complexities of medical images. This disclosure addresses these challenges by focusing on three pivotal objectives: (1) conducting a large-scale systematic study to answer critical and timely questions on transfer learning in medical image analysis; (2) describing a novel self-supervised learning framework based on the foundation of medical imaging (human anatomy) to endow models with the capability of understanding anatomy and capturing the fundamental properties of medical imaging, according to the disclosed embodiments; and (3) developing a comprehensive test suite to systematically evaluate foundation models across multiple dimensions relevant to medical imaging. Through these objectives, this disclosure provides valuable insights into the transferability, adaptability, and clinical relevance of foundation models, paving the way for more annotation-efficient and robust systems for medical image analysis.

What is claimed is:

1. A computer-implemented method for representing part-whole hierarchies in human anatomy models, comprising:
receiving a plurality of medical images; and
explicitly learning, via a self-supervised learning framework, to encode inherent part-whole hierarchies of anatomical structures in the plurality of medical images by:
acquiring discriminative representations to distinguish different anatomical structures;
learning each anatomical structure in a parts-to-whole manner; and
learning each anatomical structure in a whole-to-parts manner.

2. The computer-implemented method of claim 1, wherein explicitly learning, via a self-supervised learning framework, to encode inherent part-whole hierarchies of anatomical structures in the plurality of medical images, comprises learning, via a self-supervised learning framework comprising a localizability branch, a composability branch, and a decomposability branch, to encode inherent part-whole hierarchies of anatomical structures in the plurality of medical images;
wherein acquiring discriminative representations to distinguish different anatomical structures, comprises acquiring, via the localizability branch, discriminative representations to distinguish different anatomical structures;
wherein learning each anatomical structure in a parts-to-whole manner, comprises learning, via the composability branch, each anatomical structure in a parts-to-whole manner; and
wherein learning each anatomical structure in a whole-to-parts manner, comprises learning, via the decomposability branch, each anatomical structure in a whole-to-parts manner.

3. The computer-implemented method of claim 2, wherein acquiring, via the localizability branch, discriminative representations to distinguish different anatomical structures, comprises learning, via the localizability branch, a semantically structured embedding space by discriminating between different anatomical structures.

4. The computer-implemented method of claim 3, wherein learning, via the localizability branch, a semantically structured embedding space by discriminating between different anatomical structures, comprises the localizability branch:
receiving an anchor whole w, comprising multi-scale views, randomly sampled from an image I;
augmenting and processing w and its multi-scale views; and
enforcing consistency between embeddings of w to yield distinct features for different anatomical structures.

5. The computer-implemented method of claim 2, wherein learning, via the composability branch, each anatomical structure in a parts-to-whole manner, comprises learning, via the composability branch, part-whole relations of each anatomical structure by constructing each anatomical structure through the integration of its constituent parts.

6. The computer-implemented method of claim 5, wherein learning, via the composability branch, part-whole relations of each anatomical structure by constructing each anatomical structure through the integration of its constituent parts, comprises the composability branch:
receiving an anchor whole w, comprising multi-scale views, randomly sampled from an image I;
decomposing w into a set of parts; and
enforcing consistency between the embeddings of w and aggregated embeddings of it set of parts, thereby encoding part-whole relations.

7. The computer-implemented method of claim 2, wherein learning, via the decomposability branch, each anatomical structure in a whole-to-parts manner, comprises learning, via the decomposability branch, each anatomical structure in a whole-to-parts manner by decomposing each anatomical structure into its constituent parts.

8. The computer-implemented method of claim 7, wherein learning, via the decomposability branch, each anatomical structure in a whole-to-parts manner by decomposing each anatomical structure into its constituent parts, comprises the decomposability branch:
receiving an anchor whole w, comprising multi-scale views, randomly sampled from an image I;
decomposing embeddings of w to acquire embeddings of its constituent parts; and
enforcing consistency between the embeddings of the constituent parts and their decomposed counterparts, thereby capturing whole-part relations.

9. A system, comprising:
a memory to store instructions;
a processor to execute the instructions stored in the memory to perform the following operations:
receiving a plurality of medical images; and
explicitly learning, via a self-supervised learning framework, to encode inherent part-whole hierarchies of anatomical structures in the plurality of medical images by:
acquiring discriminative representations to distinguish different anatomical structures;
learning each anatomical structure in a parts-to-whole manner; and
learning each anatomical structure in a whole-to-parts manner.

10. The system of claim 9, wherein explicitly learning, via a self-supervised learning framework, to encode inherent part-whole hierarchies of anatomical structures in the plurality of medical images, comprises learning, via a self-supervised learning framework comprising a localizability branch, a composability branch, and a decomposability branch, to encode inherent part-whole hierarchies of anatomical structures in the plurality of medical images;
wherein acquiring discriminative representations to distinguish different anatomical structures, comprises acquiring, via the localizability branch, discriminative representations to distinguish different anatomical structures;
wherein learning each anatomical structure in a parts-to-whole manner, comprises learning, via the composability branch, each anatomical structure in a parts-to-whole manner; and
wherein learning each anatomical structure in a whole-to-parts manner, comprises learning, via the decomposability branch, each anatomical structure in a whole-to-parts manner.

11. The system of claim 10, wherein acquiring, via the localizability branch, discriminative representations to distinguish different anatomical structures, comprises learning, via the localizability branch, a semantically structured embedding space by discriminating between different anatomical structures.

12. The system of claim 11, wherein learning, via the localizability branch, a semantically structured embedding space by discriminating between different anatomical structures, comprises the localizability branch:
receiving an anchor whole w, comprising multi-scale views, randomly sampled from an image I;
augmenting and processing w and its multi-scale views; and
enforcing consistency between embeddings of w to yield distinct features for different anatomical structures.

13. The system of claim 10, wherein learning, via the composability branch, each anatomical structure in a parts-to-whole manner, comprises learning, via the composability branch, part-whole relations of each anatomical structure by constructing each anatomical structure through the integration of its constituent parts.

14. The system of claim 13, wherein learning, via the composability branch, part-whole relations of each anatomical structure by constructing each anatomical structure through the integration of its constituent parts, comprises the composability branch:
receiving an anchor whole w, comprising multi-scale views, randomly sampled from an image I;
decomposing w into a set of parts; and
enforcing consistency between the embeddings of w and aggregated embeddings of it set of parts, thereby encoding part-whole relations.

15. The system of claim 10, wherein learning, via the decomposability branch, each anatomical structure in a whole-to-parts manner, comprises learning, via the decomposability branch, each anatomical structure in a whole-to-parts manner by decomposing each anatomical structure into its constituent parts.

16. The system of claim 15, wherein learning, via the decomposability branch, each anatomical structure in a whole-to-parts manner by decomposing each anatomical structure into its constituent parts, comprises the decomposability branch:
receiving an anchor whole w, comprising multi-scale views, randomly sampled from an image I;
decomposing embeddings of w to acquire embeddings of its constituent parts; and
enforcing consistency between the embeddings of the constituent parts and their decomposed counterparts, thereby capturing whole-part relations.

17. A non-transitory computer readable storage media having instructions stored thereupon that, when executed by a system having at least a processor and a memory therein, cause the processor to perform the following operations:
receiving a plurality of medical images; and
explicitly learning, via a self-supervised learning framework, to encode inherent part-whole hierarchies of anatomical structures in the plurality of medical images by:
acquiring discriminative representations to distinguish different anatomical structures;
learning each anatomical structure in a parts-to-whole manner; and
learning each anatomical structure in a whole-to-parts manner.

18. The non-transitory computer readable storage media of claim 17, wherein explicitly learning, via a self-supervised learning framework, to encode inherent part-whole hierarchies of anatomical structures in the plurality of medical images, comprises learning, via a self-supervised learning framework comprising a localizability branch, a composability branch, and a decomposability branch, to encode inherent part-whole hierarchies of anatomical structures in the plurality of medical images;
wherein acquiring discriminative representations to distinguish different anatomical structures, comprises acquiring, via the localizability branch, discriminative representations to distinguish different anatomical structures;
wherein learning each anatomical structure in a parts-to-whole manner, comprises learning, via the composability branch, each anatomical structure in a parts-to-whole manner; and
wherein learning each anatomical structure in a whole-to-parts manner, comprises learning, via the decomposability branch, each anatomical structure in a whole-to-parts manner.

19. The non-transitory computer readable storage media of claim 18, wherein acquiring, via the localizability branch, discriminative representations to distinguish different anatomical structures, comprises learning, via the localizability branch, a semantically structured embedding space by discriminating between different anatomical structures.

20. The non-transitory computer readable storage media of claim 19, wherein learning, via the localizability branch, a semantically structured embedding space by discriminating between different anatomical structures, comprises the localizability branch:
receiving an anchor whole w, comprising multi-scale views, randomly sampled from an image I;
augmenting and processing w and its multi-scale views; and
enforcing consistency between embeddings of w to yield distinct features for different anatomical structures.

21. The non-transitory computer readable storage media of claim 18, wherein learning, via the composability branch, each anatomical structure in a parts-to-whole manner, comprises learning, via the composability branch, part-whole relations of each anatomical structure by constructing each anatomical structure through the integration of its constituent parts.

22. The non-transitory computer readable storage media of claim 21, wherein learning, via the composability branch, part-whole relations of each anatomical structure by constructing each anatomical structure through the integration of its constituent parts, comprises the composability branch:
receiving an anchor whole w, comprising multi-scale views, randomly sampled from an image I;
decomposing w into a set of parts; and
enforcing consistency between the embeddings of w and aggregated embeddings of it set of parts, thereby encoding part-whole relations.

23. The non-transitory computer readable storage media of claim 18, wherein learning, via the decomposability branch, each anatomical structure in a whole-to-parts manner, comprises learning, via the decomposability branch, each anatomical structure in a whole-to-parts manner by decomposing each anatomical structure into its constituent parts.

24. The non-transitory computer readable storage media of claim 23, wherein learning, via the decomposability branch, each anatomical structure in a whole-to-parts manner by decomposing each anatomical structure into its constituent parts, comprises the decomposability branch:
receiving an anchor whole w, comprising multi-scale views, randomly sampled from an image I;
decomposing embeddings of w to acquire embeddings of its constituent parts; and
enforcing consistency between the embeddings of the constituent parts and their decomposed counterparts, thereby capturing whole-part relations.
